(19) United States
(12) Patent Application Publication
(10) Pub. No.: US 2003/0099424 A1
(43) Pub. Date: May 29, 2003

(54) Optical gain media and methods for making and using same

(76) Inventors: Yousef Mohajer, Richmond, VA (US); Anna A. Panackal, Philadelphia, PA (US); Jaya Sharma, West Chester, PA (US); Yu-Ling Hsiao, Collegeville, PA (US); Robert M. Mininni, New Hope, PA (US); Brian Thomas, Exton, PA (US); Jingsong Zhu, Phoenixville, PA (US)

Correspondence Address: Finnegan, Henderson, Farabow,, Garrett & Dunner, L.L.P., 1300 I Street, N.W., Washington, DC, 20005-3315, US

(21) Appl. No.: 10/227,298

(22) Filed: Aug. 26, 2002

Related U.S. Application Data
(60) Provisional application No. 60/314,902, filed on Aug. 24, 2001.

(51) Int. Cl. G02B 6/12; G02B 6/02; H01S 3/14

(52) U.S. Cl. 385/14; 385/123; 385/143; 385/147; 252/582; 359/342

(57) ABSTRACT

Optical gain media and methods for making and using them are provided. An exemplary composition includes at least one suitable metal, at least one first ligand and at least one second ligand. These compositions can be used to make optical elements, components, and subsystems, including, for example, waveguides (e.g., optical fibers and films), optical amplifiers, lasers, compensated optical splitters, multiplexers, isolators, interleavers, demultiplexers, filters, photodetectors, and switches.

### DESCRIPTION OF THE INVENTION

This claims priority to U.S. Provisional Application No. 60/314,902, filed Aug. 24, 2001, which is hereby incorporated by reference in its entirety.

### FIELD OF THE INVENTION

This invention relates generally to methods and apparatus for making and using optical gain media. More particularly, this invention relates to metal ligand compositions for use in optical elements, components, subsystems, and systems, including, for example, optical waveguides, amplifiers, and lasers.

### BACKGROUND OF THE INVENTION

Optical fiber networks have been increasingly employed in long distance, metropolitan, and local access communication systems. Although these networks have substantially increased data transmissions capacity, there remains an increasing need for efficient, compact optical amplification and gain media from which various optical elements, components, and subsystems can be fabricated.

Optical communication systems based on glass optical fibers (hereinafter, “GOFs”) allow data to be transmitted over long distances with low attenuation at extremely high data transmission rates. These high rates result from the propagation of a single optical signal mode in low-loss windows of glass located at the near-infrared wavelengths such of 0.85 nm, 1.3 μm, and 1.55 μm. Recent developments in the fields of optical amplification and gain media include the use of erbium doped fused silica fiber.

Since the introduction of the erbium-doped fiber amplifier (hereinafter, “EDFA”), the last decade has witnessed the emergence of single-mode GOF as the standard data transmission medium for wide area networks (hereinafter, “WANs”), especially in terrestrial and transoceanic communication network backbones. In addition, the bandwidth performance of single-mode GOF has been vastly enhanced by the development of dense wavelength division multiplexing (hereinafter, “DWDM”), which can transmit up to 160 channels of different wavelengths of light through a single fiber, with each channel carrying multiple gigabits per second. Moreover, a signal transmission of 1 terabit (10₁₂ bits) per second was achieved over a single fiber on a 100-channel DWDM system. Enabled by these and other technologies, the bandwidth capacity of many networks is increasing as quickly as an order of magnitude per year.

The success of single-mode GOF in long-haul communication network backbones has accelerated optical networking technologies. An objective is to integrate voice, video, and data streams over all-optical systems as communication signals make their way from WANs down to smaller local area networks (hereinafter, “LANs”), fiber to the curb (hereinafter, “FTTC”), fiber to the home (hereinafter, “FTTH”), and finally to the end user by fiber to the desktop (hereinafter “FFTD”). Increased use of the Internet and the World Wide Web are demanding even higher bandwidth performance, especially in short- and medium-distance applications. Optical communication links include, however, numerous fiber connections, splices, and couplings which introduce optical loss. To compensate for this loss, relatively expensive and bulky EDFAs are used. For example, the cost of a typical commercially available EDFA can be tens of thousands of dollars and extend for lengths that are 40 meters or more. Thus, to complete the planned build-out for FTTC and FFTD could require the purchase of millions of EDFAs at a cost of hundreds of billions of dollars.

A conventional EDFA module includes a number of components. One of the most critical components in the module is the erbium-doped silica fiber (hereinafter, “EDF”). Conventional EDF performance is currently limited by a low concentration of erbium atoms (i.e., the maximum concentration is about 0.1%). Performance is also limited by clustering of the erbium atoms, which leads to a quenching of the desired photoluminescence effect, a relatively narrow emission band, a highly wavelength-dependent gain spectrum, and an inability to be fabricated in a compact, planar geometry. As a result, research efforts have been directed toward the use of other rare earth ions in fused silica glass hosts and other types of glasses, including fluoride, tellurite, and phosphate glasses.

Those efforts have been limited, however, by their inability to dissolve rare earth atoms, their limited mechanical properties, their thermal instability, and a variety of other key physical limitations. For example, Mylinski et al. (IEEE Photon. Technol. Lett., Vol. 11, pp. 973-975, (August 1999)) disclose some of the typical limitations of glass fibers, including length limitations due to upconversion effects, low ion concentration capacity, and limited mechanical flexibility. The compositions described herein can be used to make optical materials (including optical fibers, elements, components, modules, and subsystems) that overcome these and other limitations.

### SUMMARY OF THE INVENTION

The invention is directed generally to compositions that include ligands and metals for use in optical materials and applications. The metals and ligands are chosen to provide appropriate optical properties for any desired optical material or device.

In one illustrative embodiment consistent with this invention, a composition is disclosed. The composition can include at least one suitable metal, a first ligand, and a second ligand. The metal can be selected from aluminum (Al), chromium (Cr), scandium (Sc), yttrium (Y), lutetium (Lu), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), and ytterbium (Yb). This composition can include phosphinates or polymers. This composition can be used as an optical composition.

In one embodiment, the optical composition can have a transmission window of about 1200 nm to about 2000 nm, where the wavelength range is obtained with a common host platform. In another embodiment, the transmission window can be between about 1500 nm and about 1600 nm using a common host platform. In another embodiment the optical composition can have high concentrations of metals without associated quenching and upconversion penalties, allowing use of relatively short fiber lengths (e.g., as small as a few centimeters or less). In another embodiment, the optical composition can have a low intrinsic optical loss. In still another embodiment the optical composition can be drawn into single mode optical fiber, cast into films for planar waveguide applications, or used to make amplifiers, lasers, multiplexers, isolators, interleavers, demultiplexers, filters, switches, highly-sensitivite photodetectors and other optical devices.

In another embodiment, a relatively long length of fiber (e.g., tens of meters) for efficient, compact, broadband amplification (more generally, for use as gain media) is provided. The relatively long fiber can accommodate a relatively low pumping level, a reduction of packaging complexity, and an increase in network capacity.

In yet another embodiment, a method of making a complex that includes a suitable metal and an acid is provided. The method can include: (a) admixing at least one acid in at least one hydroxide salt in an inert solvent to produce a first salt, (b) optionally, recovering the first salt, (c) admixing the first salt with at least one suitable metal, (d) optionally stirring up to about 72 hours, and (e) recovering the complex.

Another illustrative complex for amplification or gain media includes ligands incorporated into a cyclic or cage structure. In one embodiment, this cyclic or caged structure can allow formation of intramolecular complexing, thereby potentially reducing intermolecular bonding and potentially resulting in the formation of highly active complexes, which do not form insoluble aggregates. In another illustrative embodiment, the association tendency of the cyclic or caged structure can increase the yield of highly active complexes. The ligand could be phosphinate, phosphate, sulfate, sulfite, thiosulfite or any other ion, or any structure capable associating with metals. In another embodiment, these complexes can be mixed with or linked to a polymer matrix, where this polymer matrix could be perhalogenated organic compounds, perfluoro, perchloro, mixed fluoro, chloro, and bromo compounds, as well as polyimides and perhalo-siloxanes.

It will be appreciated that a broad range of optical devices can be made from the above-mentioned compositions consistent with this invention.

In another embodiment consistent with this invention, a method is provided for making a gain medium. The method can include: (a) admixing at least one complex with at least one solvent to form a mixture, (b) heating the mixture to a temperature between about 50° C. and about 150° C., (c) cooling the mixture to a temperature between about 20° C. and about 30° C., (d) admixing a perfluoropolymer, and (e) forming a gain medium.

Compositions consistent with this invention can be used to fabricate a variety of optical elements, including: (a) optical waveguide materials that can be processed using conventional silicon VLSI (i.e., “very large scale integration”) fabrication methods and optical fiber drawing processes, (b) fiber amplifiers that incude materials having a low optical loss in short and medium distance optical communication networks, and (c) integrated optical components, such as low-loss splitters, that combine amplification/gain properties, split optical input signals, and maintain a high optical signal-to-noise ratio, (d) lasers, (e) modulators, and the like.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate non-limiting embodiments of the invention and together with the description, serve to explain the principles of the invention.

### BRIEF DESCRIPTION OF THE DRAWINGS

FIG. 1 shows an exemplary diagram showing optical fiber loss vs. wavelength of doped polymer blends for optical amplification and gain, consistent with this invention.

FIG. 2a shows an energy level diagram corresponding to a lasing process consistent with this invention.

FIG. 2b shows an energy level diagram for a metal-chromophore consistent with this invention.

FIG. 3 shows exemplary embodiments of branched structures consistent with this invention.

FIGS. 4a-4c shows exemplary embodiments of caged structures consistent with this invention.

FIG. 5a shows exemplary embodiments of polymer structures, which include side chains that can be the same or different, consistent with this invention. The structures show side chain and backbone functional group locations and can be random to prevent crystallization.

FIG. 5b shows another exemplary embodiment of a complex consistent with this invention. Again, the side chains can be the same or different and the structures can be random to prevent crystallization.

FIG. 6 shows a perspective view, not to scale, of an exemplary embodiment of an optical fiber with cladding partially stripped away consistent with this invention.

FIG. 7 shows a cross-sectional view of the exemplary embodiment shown in FIG. 6, taken along line 7-7 of FIG. 6, showing relative diameters of the core and cladding consistent with this invention.

FIG. 8 shows an exemplary embodiment of a polymeric fiber fabrication technique consistent with this invention.

FIG. 9a shows a cross-sectional view of an exemplary waveguide made using a composition consistent with this invention.

FIG. 9b shows exemplary simplified schematic diagrams of optical devices that can be made using compositions consistent with this invention.

FIG. 9c shows an exemplary optical amplifier module that can be made with compositions consistent with this invention

FIG. 10a shows a simplified flow chart of in situ formation of illustrative complexes consistent with this invention.

FIG. 10b shows a simplified scematic diagram of the formation of complexes shown in FIG. 10a consistent with this invention.

FIG. 11 shows an experimental setup used to measure fluorescence lifetimes consistent with this invention.

### DESCRIPTION OF THE EMBODIMENTS

As used herein, the term “element” is understood to include ions, atoms, isotopes, and species of atoms of the Periodic Table.

As used herein, the term “suitable metal” refers to one of the metals selected from aluminum (Al), chromium (Cr), scandium (Sc), yttrium (Y), lutetium (Lu), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), and ytterbium (Yb).

As used herein, the term “ligand” means monomers, polymers, oligomers, chelates, adducts, or any molecule that can be used in combination with at least one suitable metal.

The term “complex” means any combination of at least one ligand with at least one suitable metal. The complexes can be charged or uncharged.

The term “substantially free from” for example a given bond type, means having less than the number of the bond types, such that the contribution to the absorbance in the wavelength range between about 1200 nm and about 2000 nm is less than about 5×10⁻⁵ absorbance units/cm.

As used herein, the term “halide-to-hydrogen weight percent” of a molecular entity (e.g., complex, ligand or solution) is defined as (wt % of halide)/((wt % of halide)+(wt % of hydrogen)). Similarly, the term “fluoride-to-hydrogen weight percent” of a molecular entity (e.g., complex, ligand or solution) is defined as (wt % of fluoride)/((wt % of fluoride)+(wt % of hydrogen)).

Also, as used herein, the term “optical gain media” includes any material that increases an optical signal transmitted from one point to another through the material, including particularly, those materials used to form amplifiers, lasers and the like.

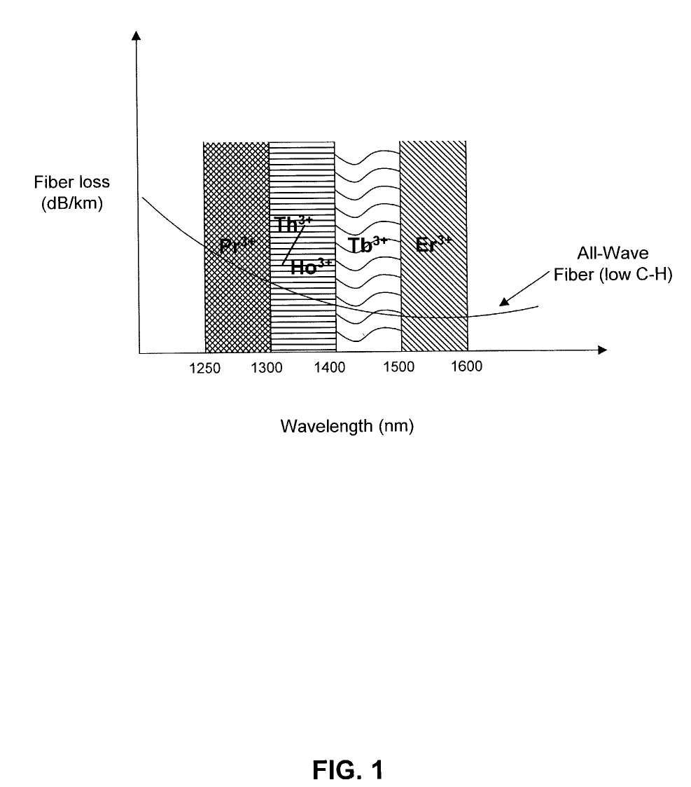

Metal waveguide amplifiers normally operate on 3 and 4 energy-level transition principles. The single pass gain of the waveguide amplifier or gain medium is, in general, the fundamental parameter to be calculated. Amplification in a suitable metal-polymer waveguide, as with most types of laser systems, can be described with a 3-level model. FIG. 1, for example, shows how the optical gain of a material can be customized to perform at various wavelengths by using different suitable metals.

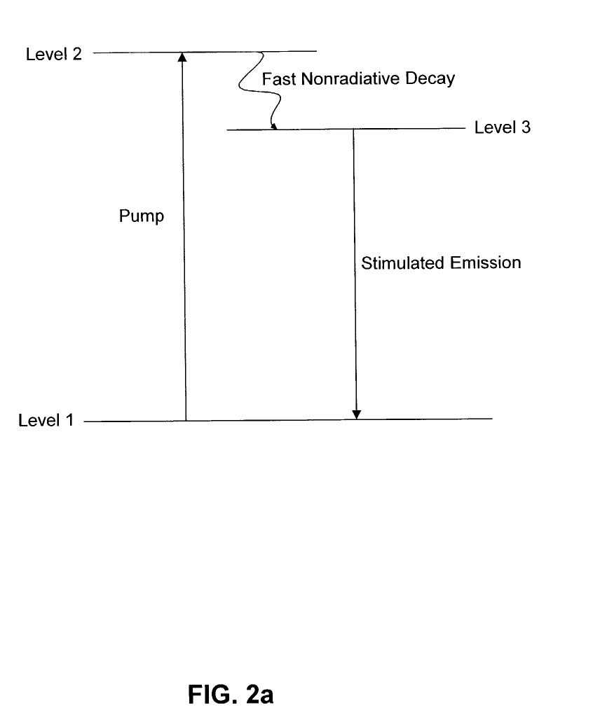

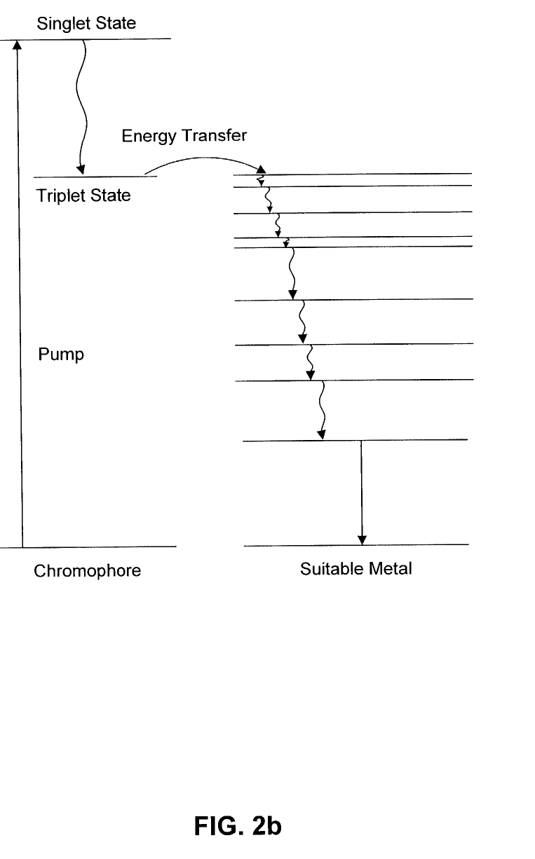

FIG. 2a shows an illustrative energy level diagram consistent with this invention. Within an amplifier, for example, the suitable metal ions within the gain media start out in their ground state (i.e., level 1). The electrons are then excited to level 2 by a pump beam of photons with energy hωₚ equal to the transition energy from level 1 to level 2. The ions subsequently undergo fast nonradiative decay to level 3, which is metastable state of the system. Because the lifetime of this metastable state is relatively long in comparison to level 2, which undergoes the nonradiative decay, a population inversion is created in level 3. Thus light passes by the ions in the gain medium and stimulates emission of photons with the same signal energy, hωₛ. This emission corresponds to the decay from energy level 3 to energy level 1, the ground state.

In one illustrative embodiment, the manifold of electronic excited states of a suitable metal ion can be altered by the presence of or encapsulation by a ligand's chromophore unit. In other embodiments, there can be one or more mechanisms to transfer energy from the ligand's chromophore unit to the suitable metal ion. In an illustrative embodiment, the excited state of the suitable metal ion can be populated by an initial selective absorption (“light harvesting”) by the ligand's chromophore unit, followed by energy transfer to the suitable metal ion. Consistent with certain embodiments of this invention, this transfer can approach unit efficiency and can thus increase the absorption cross-section by 10⁴-10⁵ times compared to that of bare suitable metal ion.

The energy level diagram corresponding to the process described above is shown in FIG. 2b. As shown, a chromophore ligand excited from its singlet state by pump light and then decays nonradiatively through intersystem crossing (IC) to its bottleneck triplet state. Radiative transitions back to the ground state are spin forbidden and, hence, the chromophore ligand can relax through energy transfer to the encapsulated suitable metal ion. This energy transfer efficiency can be increased by tuning the energy gap (e.g., through chromophore design) between the ligand triplet state and the upper level of suitable metal fluorescing transition.

The optical intensity of the transmitted signal is determined in part by the optical attenuation coefficient of an optical waveguide. The various factors contributing to optical loss in optical polymers can be divided into intrinsic and a extrinsic loss factors. Intrinsic loss can result from vibrational absorption of the polymer or complex materials, electronic transition absorption, and Rayleigh scattering. Intrinsic loss is material related and cannot be reduced without changing material composition. Extrinsic loss can result from absorption due to impurities, scattering from dust and microvoids, and imperfections in fiber parameters. Extrinsic loss is usually related to material processing and fiber fabrication, and thus can be reduced by perfecting each procedure.

Conventional optical polymers and complexes can be based on hydrocarbon (C—H) structures. A prototypical example is polymethylmethacrylate (PMMA), which has three principal loss windows located at about 570 nm, about 650 nm, and about 780 nm between absorption maxima arising from C—H vibrational overtone modes. In high optical quality samples, the principal window at about 650 nm exhibits a measured minimum loss of about 110 dB/km, which is close to a theoretical limit of about 106 dB/km. Molecular vibrations of aliphatic hydrocarbons in PMMA are the dominant intrinsic loss factor in optical polymeric waveguides. The fundamental C—H vibration occurs at about 3.2 μm. Although not wishing to be bound to any particular theory, the attenuation loss in the visible wavelength region is affected mainly by the 5th to 7th high harmonics of C—H absorption. At the 650 nm window, C—H absorption contributes about 90 dB/km to the total loss. In the near-infrared region, however, the minimum loss exceeds about 10⁴ to about 10⁵ dB/km. This loss precludes use of standard optical polymers and suitable metal chromophore structures based on these hydrocarbon structures at three commonly used telecommunications wavelengths of 850 nm, 1300 nm, and 1550 nm.

When designing an optical gain medium, potential nonradiative decay pathways should be considered. In the suitable metal doped medium, the excited suitable metal should be prevented from nonradiatively returning to its ground state via coupling to vibrational modes in the surrounding medium. This can be accomplished by assuring that vibrational modes in the medium present have relatively low energies (for example, less than about 1000 cm⁻¹). A controlled microscopically engineered method for achieving this is to incorporate at least one rare earth ion in an organic or inorganic complex that has exclusively low energy vibrations. Because high vibrations are generally caused by the presence of light atoms, a method of achieving this goal is to eliminate light atoms, such as hydrogen, from the medium. This can be accomplished, for example, in rare earth doped halogenated polymers consistent with this invention. Examples of halogenated polymers include perfluoropolymers.

The intensities of the harmonic absorption bands decrease significantly with each successive harmonic. If hydrogen is replaced with a more massive atom, the wavelengths of the fundamental vibration and subsequent harmonics shift to longer wavelength regions. The order of higher harmonics, which affects the near-infrared region, is higher, resulting in a significant decrease in vibrational absorption.

Indeed, when the short-wavelength O—H and C—H bonds are replaced by C—F bonds having a markedly longer fundamental stretch vibration at 10 μm, the resulting fluoropolymer waveguide exhibits a reduced loss of 10 dB/km with a practically flat dispersion over the near-infrared range. The primary contributing factors to the fluoropolymer loss are wavelength-independent structural waveguide imperfections and Rayleigh scattering ((α_{R}=9.5(568/λ)⁴ dB/km) based on measurements of fluorinated polymer waveguides. Losses due to electronic absorption are usually negligible as are absorptions from molecular vibrations. The number of C—F vibrational overtones are practically negligable in the visible region. In the near infrared range, the strength of overtones is typically much less than 1 dB/km, even up to about 1500 nm. Consequently, the total theoretical loss of a perfluorinated polymer waveguide can approach 10 dB/km well into the near-infrared and is less than 25 dB/km over most of the visible spectrum.

Varieties of fluoropolymers for passive optical waveguides have been developed for direct use, including, for example, ether-, perfluoromethyl-, and chloro-substituted polytetrafluoroethylenes, acrylates, silicones, polylimides, and co- and ter-polymers of polytetrafluoroethylene (PTFE) and polyvinylidene fluoride (PVDF).

The reduction (or elimination) of O—H bonds and the replacement of O—H and C—H bonds with C—F bonds in the polymer fiber waveguide core materials help over all radiative efficiency of the suitable metal systems. The O—H stretch (3600 cm⁻¹) and C—H stretch (3200 cm⁻¹) vibrations play a dominant role in phonon-assisted, nonradiative removal of electronic excitation energy from excited suitable metal ions. These nonradiative processes reduce radiative efficiency and, consequently, degrade amplifier device performance. Phonon-assisted decay decreases exponentially with increased number of phonons required to span the energy gap between the metastable state and the ground state. In suitable metal halo-complexes consistent with this invention, high-frequency O—H and C—H bonds can be replaced by C-halogen bonds that possess considerably reduced frequency vibrations (˜1000-1200 cm⁻¹), and as a consequence, the suitable metal sites exhibit long metastable(˜1-10 ms) lifetimes.

In one illustrative embodiment of a complex-comprising composition consistent with this invention, small amounts of molecular entities, compounds, ligands, and/or complexes that have O—H or C—H bonds can be included in the composition to enhance or at least modify desired properties of the composition, as desired.

In one illustrative embodiment, the complex-comprising composition is substantially free from at least one of the following C—H, S—H, N—H, O—H, P—H, Si—H, C═O, C═N, C═S, C═C, N═O, C≡C, and C≡N. In other embodiments, the absorbance per cm is less than about 5×10⁻⁵, less than about 2.5×10⁻⁵, or less than about 1.0×10⁻⁵, where these absorbances are in a wavelength range of about 1200 nm to about 2000 nm, or about 1250 nm to about 1700 nm, or about 1250 nm to about 1350 nm, or about 1500 nm to about 1600 nm.

General classes of high optical transparency suitable metal halocomplexes for optical gain media and their applications consistent with this invention are disclosed in the formula and chemical structures taught below. A basic halo-ligand structure avoids the introduction of O—H and C—H bonds and can use C-halo bonds. The Er³⁺ ion concentration in these novel complexes can be relatively high, for example, on the order of 10²¹ ions/cm³ (˜1.7 M). Also taught is the use of commercially available fluoropolymers for cladding materials with suitable metal halo-complexes. In addition to Er³⁺, other suitable metal ions, as well as combinations of suitable metal ions, can be encapsulated at high concentrations in a basic polymer structure.

In one exemplary embodiment, the complex-comprising composition has a total concentration of suitable metals that can be greater than about 0.1% with a lifetime of the composition being greater than about 1.5 ms.

In one exemplary embodiment, the complex-comprising composition has a total concentration of suitable metals that can be greater than about 5.9% with a lifetime of the composition being greater than about 5.0 ms.

In another embodiment, the complex-comprising composition can have a total concentration of suitable metals greater than about 1.0% with a lifetime of the composition being greater than about 3.8 ms.

The basic structure of suitable metal complexes consistent with this invention can be an isolated single suitable metal ion encapsulated by a molecular “coordination shell.” In one embodiment, to create such a shell, halogenated organic phosphinate ligands can be used with coordinating donor atoms, such as oxygen, to chemically bond to the suitable metal ions. This is believed to isolate the suitable metal ion and form a physico-chemical barrier for the suitable metal ion.

These suitable metal complexes are compatible with high-temperature fluorinated polymers, which are suitable as passive cladding materials. Suitable metal concentrations of —10²⁰-10²¹ ions/cm³ (equivalent to ˜0.17-1.7 M and ˜1.0-10% wt/wt) have been achieved with no undesirable effects, such as clustering and lifetime quenching. In some exemplary embodiments, the total suitable metal concentration can be in the range of about 1×10⁻³ M to about 3.0 M, or about 0.01 M to about 2.0 M, or about 0.01% to about 20%, or about 0.1% to about 10%. These relatively high concentrations are to be compared to the 0.1% concentration limit common to most silica glasses and inorganic crystals.

Optical gain can be achieved in rare earth doped halogenated complexes as previously described in copending, commonly owned U.S. patent applications Ser. No. 09/507,582, filed Feb. 18, 2000, and Ser. Nos. 09/722,821 and 09/722,282, both filed Nov. 28, 2000, which are all hereby incorporated by reference in their entireties.

Some exemplary ligands that can be used to make complexes of the present invention are given below. Other halogenated phophinic acid ligands are described in commonly owned Mininni et al. U.S. patent application Ser. No. 10/______ “Processes For The Preparation of Fluorinated And Halogenated Phosphinic Acids And Their Active Metal Derivatives,” filed Aug. 26, 2002, which is hereby incorporated by reference in its entirety.

Some of the ligands and complexes use the following definitions.

Me is methyl.

^{t}Bu is tert-butyl.

ⁿBu is n-butyl.

An “F” inside of a cyclic structure indicates perfluorination.

A₁ and A₂ can be the same or different and are selected from N, S, and O.

A₃, A₄, A₅ and A₆ can be the same or different and are selected from P, and N.

A₇ is selected from S and O.

A₈ and A₉ can be the same or different and are selected from O, S, Se, Te, Po, and N.

A₁₀ is selected from B, Ge, Ga, N, P, As, Sb, Bi, S, C, and Si (wherein if A₁₀ is C or Si, then A₁₁R₁=nothing).

A₁₁ and A₁₂ can be the same or different and are selected from O, S, N, and nothing.

A₂₀, A₂₁, and A₂₂ can be the same or different and are selected from O, S, Se, Te, and Po.

A₂₃ is selected from S, Se, Te, and Po.

A₂₅, A₂₈ can be the same or different and are selected from P, As, Sb, and Bi.

A₂₆ A₂₇, A₂₉, and A₃₀ can be the same or different and are selected from O, S, Se, Te, and Po.

A₃₅ is selected from O and S.

A₃₆ is selected from —OH, —SH, and —OR₈₀.

M, M₁, M₂, M₃, and M₄ can be the same or different and are selected from aluminum (Al), chromium (Cr), scandium (Sc), yttrium (Y), lutetium (Lu), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), and ytterbium (Yb).

G is selected from nothing, p-C₆(X)₄, and p-C₆(X)₄—C₆(X₁)₄.

G₁, G₂, G₃, G₄, G₅, G₆, G₇, G₈, G₉, G₁₀, G₁₁, G₁₂, and G₁₃ can be the same or different and are

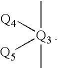

Q₁ and Q₂ can be the same or different and are selected from P, As, and Sb.

Q₃ is selected from N, P, As, and Sb.

Q₄ and Q₅ can be the same or different and are selected from O, S, Se, and Te.

Q₆ is selected from B, As, and P.

Q₇ is selected from As and P.

Q₈ is selected from C and Si.

X, X₁, X₂, X₃, X₄, X₅, X₆, X₇, and X₈ can be the same or different and are selected from H, F, Cl, Br, and I.

X₉, X₁₀, X₁₁, and X₁₂ are selected from F, Cl, Br, and I.

Z is Q₂(R₃)₃ or an oligophosphoranyl group.

i, j, k, and I can be the same or different and are positive, rational numbers that are greater than zero, and less than about 1000, or less than about 100, or less than about 25, or less than about 10.

n, m, and p can be the same or different and are selected from any integer of 1 to 100, or 1 to 20, or 1 to 10.

R_{f} is selected from perflourinated alkyl, perflourinated aryl, perflourinated cyclic alkyl, perflourinated arylalkyl, and perflourinated alkylaryl.

R_{f1}, and R_{f2} can be the same or different, can be branched or unbranched, can be linked to form cyclic or extended structures, and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, halogenated silazanes, halogenated olefins, fluorinated alkyl, fluorinated aryl, fluorinated cyclic alkyl, fluorinated arylalkyl, fluorinated alkylaryl, fluorinated polyether, fluorinated thioether, fluorinated ether thioether, fluorinated aklyl amino groups, fluorinated alkylene, fluorinated silylene, fluorinated siloxanes, fluorinated silazanes, fluorinated olefins, branched perfluorinated C₁₋₂₀ alkyl, unbranched perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)ₙ, n-C₁₀F₂₁, n-C₁₂F₂₅, (CF₃)₂CF(CF₂)₆, and (CF₃)₂CFO(CF₂)₂.

R₁, R₂, R₃, R₄, R₅, R₆, R₇, and R₈ can be the same or different, can be linked to form cyclic or extended structures, and are selected from halide, halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, and halogenated silazanes.

R₉ is selected from HO— and HS—.

R₁₀, R₁₁, and R₁₂ can be the same or different and are selected from R₅₀, R₅₁, R₅₂, R₅₃, R₆₀, R₆₀O—, R₆₀S—, R₆₁, R₆₁O—, R₆₁S—, HO—, and HS—.

R₂₁, R₂₂, and R₂₃ can be the same or different and are selected from H, a branched or linear alkyl group having 1-50 carbon atoms, a branched or linear alkenyl group having 1-50 carbon atoms, a branched or linear halogenated alkyl group having 1-50 carbon atoms, —C(O)H, —COOH, —O—R₃₀, —O—R₃₀—OH, —R₃₀—OH, —COOR₃₀, COOR₃₀—C(O)H, —COOR₃₀—COOH, O—R₃₀—NH₂, —NO₂, and an amine group.

R₂₄, R₂₅, and R₂₆ can be the same or different and are selected from —(CH₂)₀₋₃COOH, —(CH₂)₀₋₃COOR₂₉, —(CH₂)₀₋₃SO₃H, —(CH₂)₀₋₃SO₃R₂₉, (CH₂)₀₋₃—O—P(O)(OR₂₉)₂, (CH₂)₀₋₃—O—P(O)OH(OR₂₉), —(CH₂)—O—P(OR₂₉)₃, —(CH₂)₀₋₃—O—POH(OR₂₉)₂, and —(CH₂)₀₋₃—O—P(O)H(OR₂₉).

R₂₇ and R₂₈ can be the same or different and are selected from —C(O)—O—R₃₀, —C(O)—COOH, —CH(O)—COOR₃₀, and —C(O)—NR₃₀R₃₀, and further may joined to form a cyclical compound selected from —CH₂—O—(CH₂—CH₂—O—)O₀₋₃—CH₂—, —(CH₂N(R₃₀)—CH₂)₁₋₄—, —C(O)—NR₃₀—R₃₁—NR₃₀—C(O)—, and —C(O)—O—R₃₁—O—C(O).

R₂₉ is a branched or linear alkyl group having 1 to 3 carbon atoms or a phenyl group.

R₃₀ is a branched or linear alkyl group or branched or linear alkenyl group having 1 to 50 carbon atoms.

R₃₁ is a branched or linear alkyl group having 2 to 8 carbon atoms.

R₄₀ and R₄₁ can be the same or different and are selected from H, F, CH₃, C₄H₉, C₅H₁₁, C₆H₅, C₆F₅, C₆H₁₃, C₇H₁₅, C₇H₇, C₈H₁₇, C₁₄H₁₂O, and CB₁₀H₁₀CCH₃.

R₄₂ and R₄₃ can be the same or different and are selected from F₃C—, thenoyl C₄H₃S—, furanoyl C₄H₃O—, t-butyl, and perfluoro-n-propyl (C₃F₇).

R₅₀, R₅₁, R₅₂, and R₅₃ can be the same or different and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, halogenated silazanes,

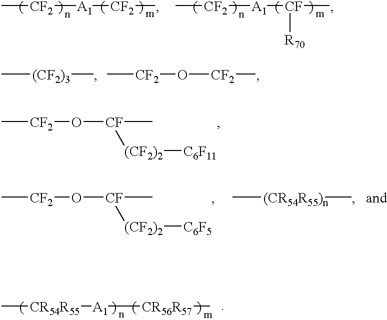

R₅₄, R₅₅, R₅₆, and R₅₇ can be the same or different and selected from F, Cl, Br, I, halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes and halogenated silazanes, halogenated polyamide, halogenated polyether, halogenated polyimide, halogenated polythioethers, —(CF₂)ₚ—CF₃, —(CF₂)ₚ—C₆F₅, and —(CF₂)ₚ—C₆F₁₁.

R₆₀, R₆₁, and R₆₂ can be the same or different and are selected from (a) substituted or unsubstituted alkyl radicals, such as amyl, isoamyl, hexyl, heptyl, octyl, the isomeric octyls, octadecyl, lauryl, dodecyl (normal or branched chain), tetradecyl, and cetyl (normal or branched chain) radicals, (b) substituted or unsubstituted aryl, such as the phenyl, diphenyl, and naphthyl, radicals, (c) substituted or unsubstituted aralkyl, such as phenyloctadecyl and similar alkyl radicals connected to the central acid-forming atom, e.g. boron or arsenic, and having an aryl group as a substituent in the alkyl chain, (d) substituted or unsubstituted alkaryl, such as octadecylphenyl, tetradecylphenyl, decylphenyl, hexylphenyl, methylphenyl, cetylphenyl, and other radicals where the aryl group is directly attached to the central acid-forming atom, e.g. boron or arsenic, and is substituted with an alkyl group, (e) substituted or unsubstituted radicals containing ether, sulfide, and ester groups, (f substituted or unsubstituted cyclic nonbenzenoid radicals, such as cyclohexyl or other alicyclic radicals, and (g) substituted or unsubstituted oxy radicals, such as those in which the hydrogen of an hydroxyl group has been replaced by esterification, etherification, neutralization with a metal, or the like, substituted or unsubstituted radicals containing thio, amino, halogen, or other groups.

R₇₅ and R₇₆ can be the same or different and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, and halogenated silazanes.

R₈₀ can be branched or unbranched and is selected from C₁₋₆ alkyl, C₁₋₁₅ alkyl, C₃₋₁₅ aryl, C₄₋₁₅ alkylaryl, and C₄₋₁₅ arylalkyl.

When two or more ligands are chosen to form a complex and one or more variables from each ligand has the same designation (e.g., both ligands have the variable designation R₁), these variables can be the same or different for each ligand. The ligands can be charged or uncharged. The ligands as shown can be further halogenated, further fluorinated, perhalogenated, and/or perfluorinated.

Exemplary ligands include: benzoyl acetonate; dibenzoyl methane (dbm); 1,1,1-trifluoro-2,4-pentanedion (tfd); 1,1,1,5,5,5-hexafluoro-2,4-pentanedion (hfd); 2,2′-bipiperazine (bpip); 2,4-pentanediamine (ptdn); picolylamine (pic); 1,8-naphthyridine (napy); tris(2-pyridylmethyl)amine (tmpa); salicylidene aminate (salam); N,N′-disalicylidene ethylenediamine (salen); N-salicycildene cyclohexyl aminate (salch); 1,1,1,3,5,5,5-heptafluoro-2,4-pentanedion (hepfd); 1,1,1,5,5,5-hexafluoro-3,3-deutero-2,4-pentanedion (hfdd); thenoyl trifluoroacetonate (ttfa); 1,1,1,5,5,6,6,6-octafluoro-2,4-hexanedion (ofhn); 1,1,1,5,5,6,6,7,7,7-decafluoro-2,4-heptanedion (dfhn); pentafluorobenzoyl trifluoroacetonate (ofpbd); bis(pentafluorobenzoyl)methane (dfdbm); pentadecafluorooctanoic acid (pdoa); N,N′-disalicylidene-1,2-cyclohexylenediamine (dsalch); acetyl (CH₃CO, Ac); acetylacetonate (CH₃COCHCOCH₃, acac); 2,2′-dipyridine, or bipyridine (bpy); benzyl (C₆H₅CH₂, Bz); cycloocta-1,5,-diene (C₈H₁₂, cod); cyclooctatetraene (C₈H₈, cot); cyclopentadienyl (C₅H₅, Cp); benzene; pentamethylcyclopentadienyl (Cp*);

cyclohexyl (C₆H₁₁, Cy); dibenzylmethyl (C₆H₅COCHCOC₆H₅, dbm); dimethoxyethane (CH₃OCH₂CH₂OCH₃, dme); N,N′-dimethylformamide (HCON(CH₃)₂, dmf); 1,2-bis(dimethylphosphino)ethane ((CH₃)₂PCH₂CH₂P(CH₃)₂, dmpe); 1,2-bis(dimethylphosphino)methane ((CH₃)₂PCH₂P(CH₃)₂, dmpm); ethane-1,2-dithiolate (SCH₂CH₂S, edt); C₆H₄(C₂H₅)COCHCOC₆H₄(C₂H₅) (Et2dbm);

hexamethylphosphoric triamide (OP(N(CH₃)₂)₃, hmpa); toluene; 2,4,6-trimethylphenyl (Mes, mesityl); NC₆H₄CH₃ (NtoI); neopentoxide; benzoate; CH₃C₆H₄CO₂; oxalate (C₂O₄, ox); phenyl (C₆H₅, ph); phthalic acid (C₆H₄(COOH)₂); picolinate; pyridine; pyrazole (C₃H₄N₂); salicylaldehyde (C₆H₄(OH)(CHO), sal); tolyl (CH₃C₆H₄, tol);

triflate (CF₃SO₃ ); 1,4,7,10,13,16-hexaoxacyclooctadecane (18-crown-6); glycine; alanine; valine; leucine; isoleucine; methionine; phenylalanine; tryptophane; serine; threonine; asparagine; glutamine; aspartic acid; glutamic acid; cysteine; tyrosine; histidine; lysine; arginine; adenine; cytosine; uracil; guanine; thymine; oxygen(O); halogen; hydroxyl(OH); carbon monoxide (CO); water (H₂O); C₆H₄O₂; C₆H₁₂O₂; —OC₄H₉; —OC₃H₇; —OCH₃; —C₇H₄O₃; —C₅H₇O₂; —OOC₅H₄N; —Ch₃; —C₃H₇; —C₄H₉; carbanyldicyanomethanide (cda); di(2-ethylhexyl)phosphoric acid

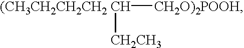

dehp); 5,10,15,20-tetraphenyl porphyrin (TPP); 2,6 diaminopyridine; polymers made from O₂CCH₂CO₂; polymers made from diberzoylmethane; fluorescein; —P(OCH₃)₃; R₁CH(SO₂R_{f})₂; fluorocarbon acid; triphenylphosphine (Ph₃P); Me₃P; ⁿBu₃P; CH₃CN; PEt₃; P(OPh)₃; tetramethylethyldiamine (tmen); FSbF₅; FBF₃⁻; OPOF₂⁻; FPF₅⁻; FAsF₅⁻; FReF₅⁻; OTeF₅⁻; R₁R₂C(SO₂CF₃)₂; R₁N(SO₂CF₃)₂; R₁R₂P—CH₂—CH₂—PR₃R₄; theroyltrifluoroacetones; (C₆H₁₁)₂P(CH₂)₃P(C₆H₁₁)₂ (depe); ^{t}Bu₂P(CH₂)₂P^{t}Bu₂(dbpe); (C₆H₁₁)₂P(CH₂)₃P(C₆H₂)₂ (dcpp); ^{t}Bu₂P(CH₂)₃P^{t}Bu₂(dbpp) o-^{t}Bu₂PCH₂C₆H₄CH₂P ^{t}Bu₂ (dbpp); OPR₄₀R₄₁O; 1,3-diketones such as acetylacetonate, benzoylacetonate, benzoylbenzoate, trifluoro-2-furylacetylacetone; phthalates and naphthalates such as dinaphthoylmethide; dipyridines and terpyridines such as 2,2′-bypyridine-1,1′-dioxide, 2,2′,6′,2″-terpyridine, 4,4′-dimethyl-2,2′-dipyridine; and phenanthrolines such as o-phenanthroline isothiocyanate and the like; trioctylphosphine oxide (TOPO); perfluorinated sulfonate polymers; phenantroline; thenoyltrifluoroacetylacetonate; beta-diketonates R₄₂C(OH)CHCOR₄₃; anions of aromatic carbonic acids such as benzoic acid, picolinic acid (C₅H₄NCOOH) and dipicolinic acid; pyridine and derivates thereof; trialkyl-, alkylphenyl-, and triphenyl-phosphinoxide; dialkyl-, alkylphenyl-, and diphenyl-sulfoxide, alkyl-, alkylphenyl-, and phenyl-amine; alkyl-, alkylphenyl-, and phenylphosphate; 2,2′bipyridine; 2,2′,6,2″terpyridine; 1,10phenantroline; N,N,N′,N′-tetramethylethylene diamine and derivatives thereof; [C₆H₅C(O)CH₂]P(O)(OH)₂; [C₆H₅C(O)CH₂]₂P(O)OH); [C₆H₅C(O)CH₂]₂P(O)OCH₃; [C₆H₅C(O)CH₂]₂P(O)OC₂H₅; [C₆H₅C(O)CH₂]₂P(O)OC₆H₄Cl; (C₆H₅)₂P(O)OH; (C₆H₅—CH═CH)₂P(O)OH; (C₆H₅—C≡C)₂P(O)OH; (C₆H₅)₂P(O)OH; (C₆H₅)(CH₃)P(O)OH; (CH₃)₂P(O)OH; (C₆H₅)₂As(O)OH; (CH₃)₂As(O)OH; C₆H₅C(O)OH; NH₃CH₂P(C₆H₅)O₂; lipids; polymers; polyamines; schiff bases; β-diketones including benzoyltrifluoroacetone, dibenzoylmethane, ditheonylmethane, furoylacetone, 2-furoylbenzoylmethane, 2-furoyltrifluoroacetone, hexafluoroacetylacetone, 1-acetyl-1-methyl acetone, β-naphthoyltrifluoroacetone, 2-theonylacetone, 2-theonyltrifluoroacetone (4,4,4-trifluoro-1,2-thienyl-1,3-butanedione), 1,1,1-trifluoroacetylacetone, 1,3-diphenyl-1,3-propanedione and 1-phenyl-1,3-butanedione; hydroxyaldehydes including those derived from benzene and naphthalene, and their alkyl, alkoxy, and halo-substitution derivatives, such as 3-chlorosalicylal-dehyde, 5-chlorosalicylaldehyde, 4,6-dimethylsalicylaldehyde, 2-hydroxy-1-naphthaldehyde, and 2-hydroxy-3-naphthaldehyde; hydroxy acids including salicylic acid, anthraquinone carboxylic acid, and naphthoic acids; 8-hydroxyquinoline and its alkyl, aryl, and halo-substituted derivatives; —NCS; OPPh₃; NO₃; ethyne (acetylene); R₁—CFCO₂⁻; S₂CNR₁R₂; S₂P(C₆HᵢFⱼ), where i+j=5; —N(Si(R₁)₃)(Si(R₂)₃); R₁R₂P═N—R₃; (n—C₈H₁₇)₃P═O; (n-C₈F₁₇)₂POOH; (n-C₆F₁₃)₂POOH; (i-C₃F₇OC₂F₄)₂POOH; (n—C₄F₉)₂POOH; [(CF₃)₂CF(CF₂)₆]POOH; [(CF₃)₂CF(CF₂)₆]PSOH ; (n-C₁₀F₂₁)₂POOH; (CH₃)₃C—(CO)—CH₂—(CO)—CF₂CF₂CF₃]; [(A₈A₉)A₁₀(A₁₁R₁)(A₁₂R₂)]; [NR₃A₈A₁₀R₁R₂]; [N(R₁)R₇₀(NR₂]; [(NR₁R₂)(NR₃R₄)]; [A₂₀A₂₁A₂₂A₂₃R₁]; [R₇₅R₇₆A₂₅(A₂₆A₂₇)]; [R₅₀A₂₅(A₂₆A₂₇]; [R₅₀A₂₅(A₂₆A₂₇)R₅₁A₂₈(A₂₉A₃₀)];

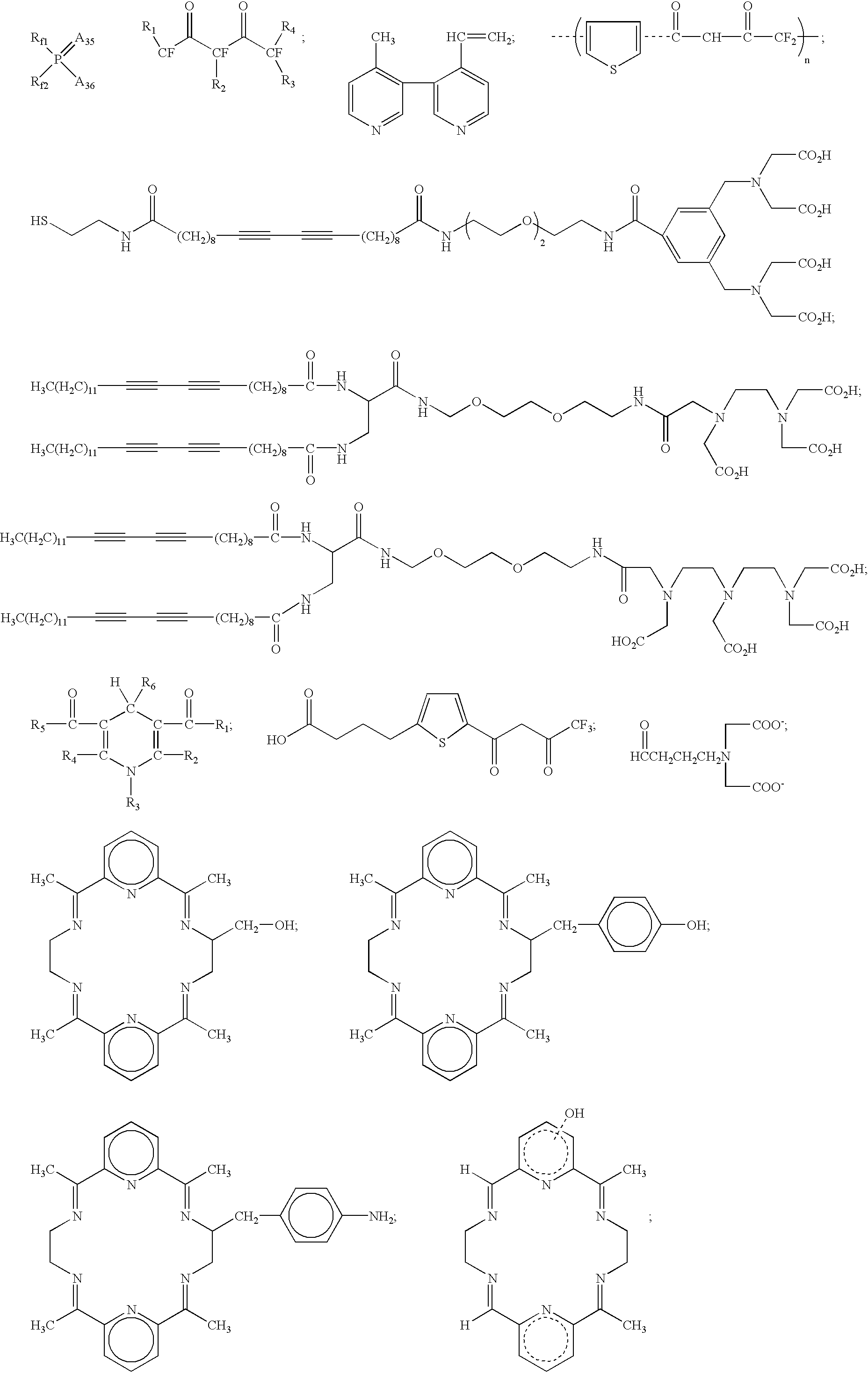

Acids of boron containing an organic substituent such as

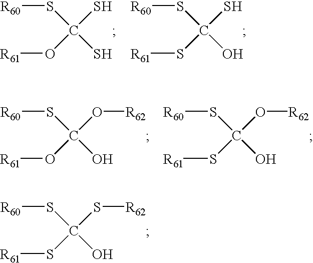

Acids of silicon containing an organic substituent, such as

R₆₀—Si—(OH)₃;

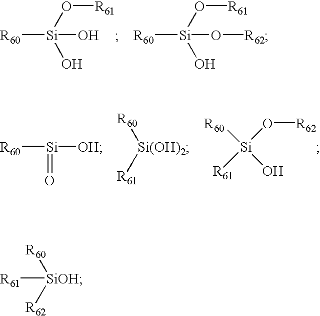

Partial esters of:

Mono-orthosilicic acid (H₄SiO₄);

Diorthosilicic acid (H₆Si₂O₇);

Triorthosilicic acid (H₈Si₃O₁₀);

Tetraorthosilicic acid (H₁₀Si₄O₁₃);

Pentaorthosilicic acid (H₁₂Si₅O₁₆);

Monometasilicic acid (H₂SiO₃);

Dimetasilicic acid (H₄Si₂O₆);

Trimetasilicic acid (H₆Si₃O₉);

Pentametasilicic acid (H₁₀Si₅O₁₅);

Dimesosilicic acid (H₂Si₂O₅);

Trimesosilicic acid (H₄Si₃O₈);

Tetramesosilicic acid (H₆Si₄O₁₁);

Pentamesosilicic acid (H₈Si₅O₁₄);

Triparasilicic acid (H₂Si₃O₇);

Tetraparasilicic acid (H₄Si₄O₁₀);

Pentaparasilicic acid (H₆Si₅O₁₃);

Tetratetrerosilicic acid (H₂Si₄O₉);

Pentatetrerosilicic acid (H₄Si₅O₁₂);

Penterosilicic acid (H₂Si₅₁₁);

Acids of phosphorus containing an organic substituent, such as

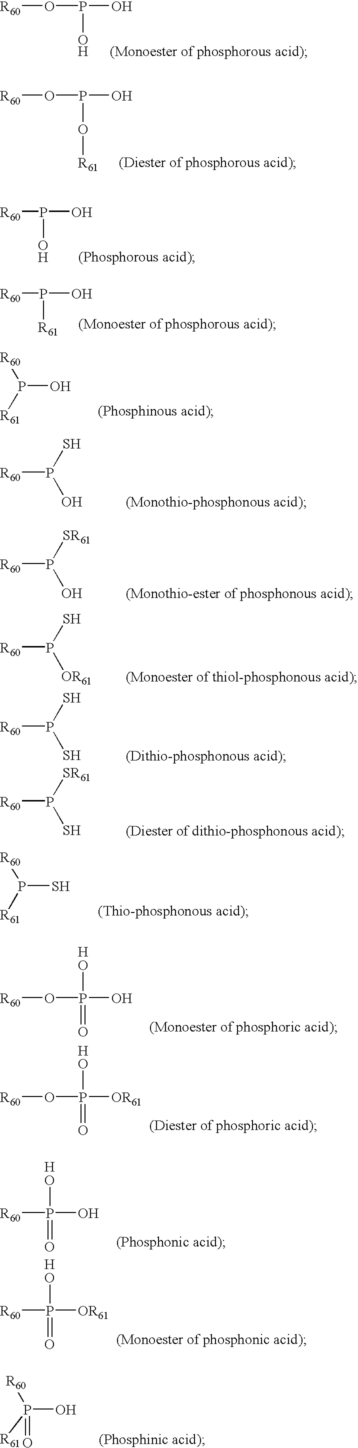

Some exemplary embodiments of complexes are listed below.

Er[(n-C₈F₁₇)₂POO]₃; ErYb[(n-C₈F₁₇)₂POO]₆; ErYb₄[(n-C₈F₁₇)₂POO]₁₅; ErYb[(n-C₆F₁₃)₂POO]₆; ErYb₄[(i-C₃F₇OC₂F₄)₂POO]₁₅; ErYb[(n-C₄F₉)₂POO]₆; ErYb₃[((CF₃)₂CF(CF₂)₆)₂POO]₁₂; ErYb₃[((CF₃)₂CF(CF₂)₆₂PSO]₁₂; ErYB₃[n-C₁₀F₂₃)₂POO]₁₂; ErYb₃[(n-C₈F₁₇(n-C₁₀F₂₃)POO]₁₂; Er[(CH₃)₃C—(CO)—CH₂—(CO)—CF₂CF₂CF₃]₃]₃; ErYb[(n-C₈F₁₇)₂POO]₆; ErYb₁₀[(n-C₈F₁₇)₂POO]₃₃;

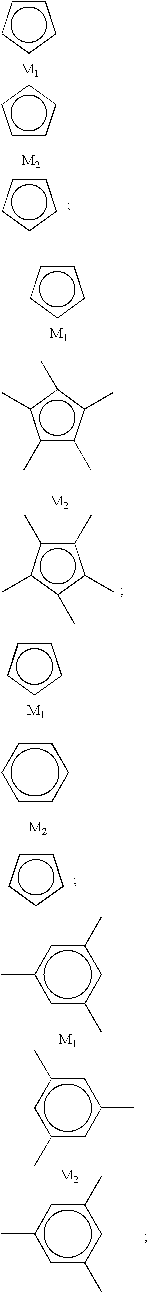

[M(PMe₃)₄]Cl;

M[N(Si(CH₃)₃)₂]₃;

M[N(Si(CH₃)₃)₂]₃OPPh₃;

[M(CH₂Si(CH₃)₃)₄]⁻;

[M(NCS)₆]³⁻;

Na[M(S₂CN(C₂H₅)₂)₄];

[M(mesityl)₄]⁻;

M(CF₃CO₂)₃(C₄H₈SO)₂;

Cs[M(CF₃COCFCOCF₃)₄];

M(PF-acac)₃;

M(HMPA)₃(X₉)₃;

M(OPPh₃)₃;

(DMSO)ₙM(NO₃)₃;

M[N(Si(CH₃)₃)₂]₂(Al(CH₃)₃)₂;

(M)₃en₃(X₉)₃;

[Men₄CF₃SO₃]²⁺;

[M(NCS)₆]³⁻;

[M(S₂CNR₂)₄]⁻;

[M(S₂P(CH₃)₂)₄]⁻;

M[S₂P(C₆H₁₁)₂]₃;

Cp₂MC₆F₅;

M(C₈H₈);

[M(C₈H₈)₂]²⁻;

M₁M₂M₃[(NR₁R₂)(NR₃R₄)]X₉;

M₁M₂M₃[(A₈A₉)A₁₀(A₁₁R₁)(A₁₂R₂)]₃;

(M₁)ᵢ(M₂)ⱼ(M₃)ₖ(M₄)ₗ[R₇₅R₇₆A₂₅(A₂₆A₂₇)]₃₍ᵢ₊ⱼ₊ₖ₊ₗ₎;

(M₁)ᵢ(M₂)ⱼ(M₃)ₖ(M₄)ₗ[R₅₀A₂₅(A₂₆A₂₇)]₃₍ₗ₊ⱼ₊ₖ₊ₗ₎; and

(M₁)ᵢ(M₂)ⱼ(M₃)ₖ(M₃)ₗ[R₅₀A₂₅(A₂₆A₂₇)R₅₁A₂₈(A₂₉A₃₀)]_{1.5(l+j+k+l)}, where R₅₀ and R₅₁ are each linked to both A₂₅ and A₂₈;

Other exemplary embodiments of complexes include:

M₁M₂M₃[NR₃A₈A₁₀R₁R₂]₃

where:

A₈, A₉, A₁₀, A₁₁, A₁₂, M₁, M₂, M₃, R₁, R₂, and R₃ are defined above but here, R₁ and R₂ can be separate groups or can be linked to form cyclic or extended structures; and

each of the three [(A₈A₉)A₁₀(A₁₁R₁)(A₁₂R₂)] can be the same or different.

M₁M₂M₃[N(R₁)R₇₀(NR₂)]X₉

where:

M₁, M₂, M₃, R₁, R₂ and X₉ are defined above; and

R₇₀ is halogenated alkylene or halogenated silylene.

M₁M₂M₃[A₂₀A₂₁A₂₂A₂₃R₁]₃

where:

A₈, A₉, A₁₀, A₁₁, A₁₂, A₂₀, A₂₁, A₂₂, A₂₃, M₁, M₂, M₃, and R₁ are defined above; and

wherein each of the three [A₂₀A₂₁A₂₂A₂₃R₁] can be the same or different.

The present invention also contemplates such complexes in combination with polymers having low absorption from 1200 to 1700 nanometers. These combinations can be made by blending the complex with a preform polymer or by mixing such complex with monomer(s) and then polymerizing. Alternatively, a polymer can be produced from any of the complexes (or any of the above-mentioned ligands used to make a complex) providing that the complex contains polymerizable moieties.

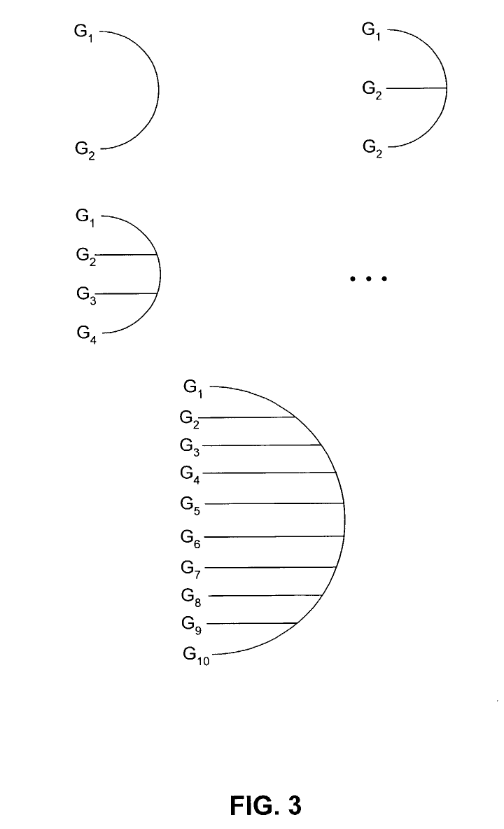

FIG. 3 discloses exemplary embodiments of branched polymers where from 2 to 10 groups (Gᵢ) can coordinate with one or more suitable metals.

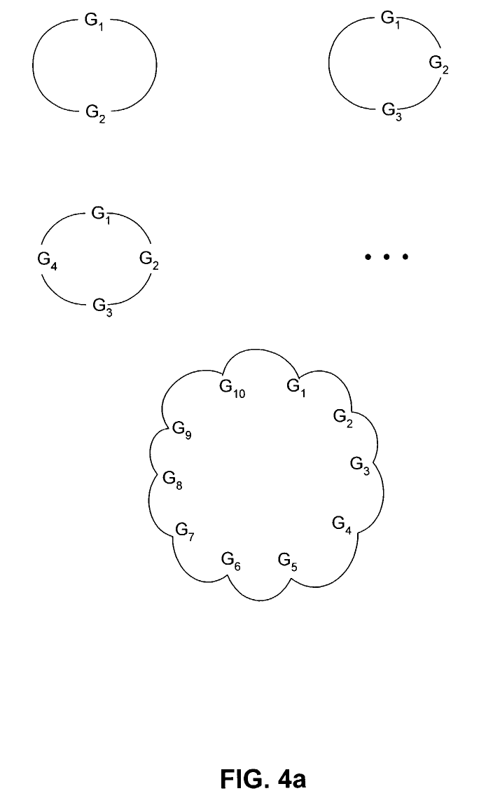

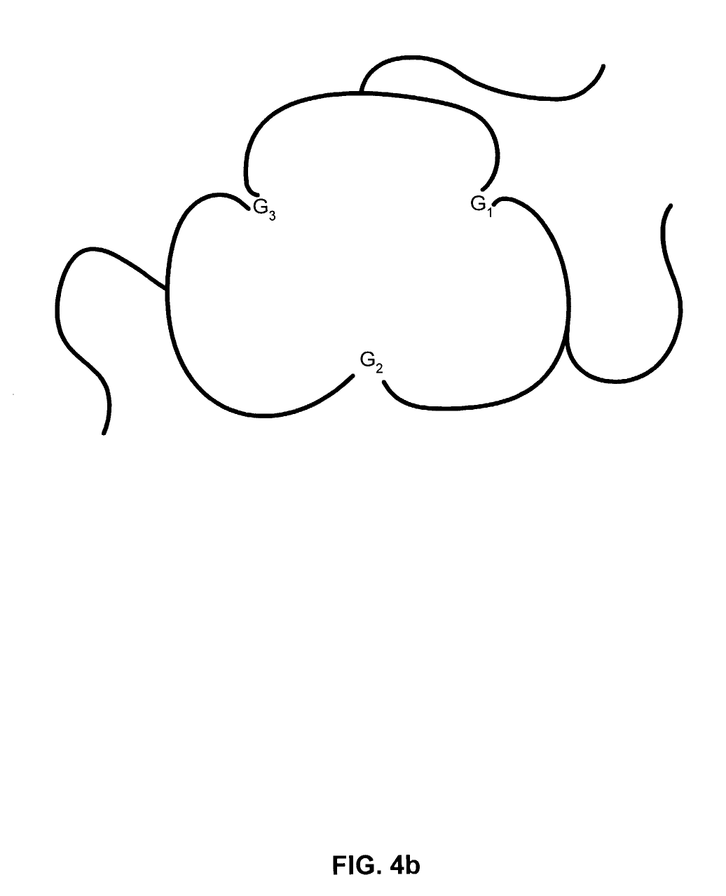

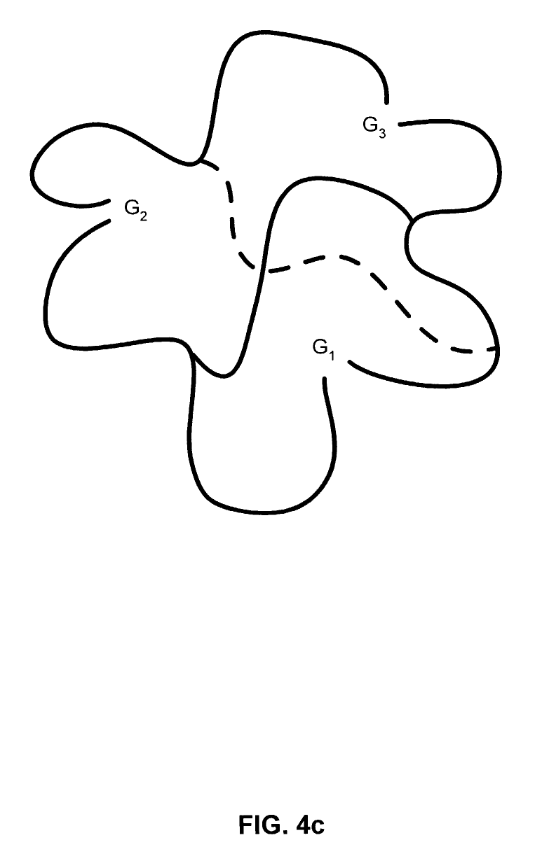

Exemplary embodiments further include cage structures wherein the suitable metal is caged within one or more of the complexes described herein. FIG. 4a discloses exemplary embodiments of cage polymers and structures where from 2 to 10 groups (Gᵢ) can coordinate with one or more suitable metals. FIGS. 4b and 4c show additional illustrative cage structures consistent with this invention.

Some of the cage structures that can be used consistent with this invention include:

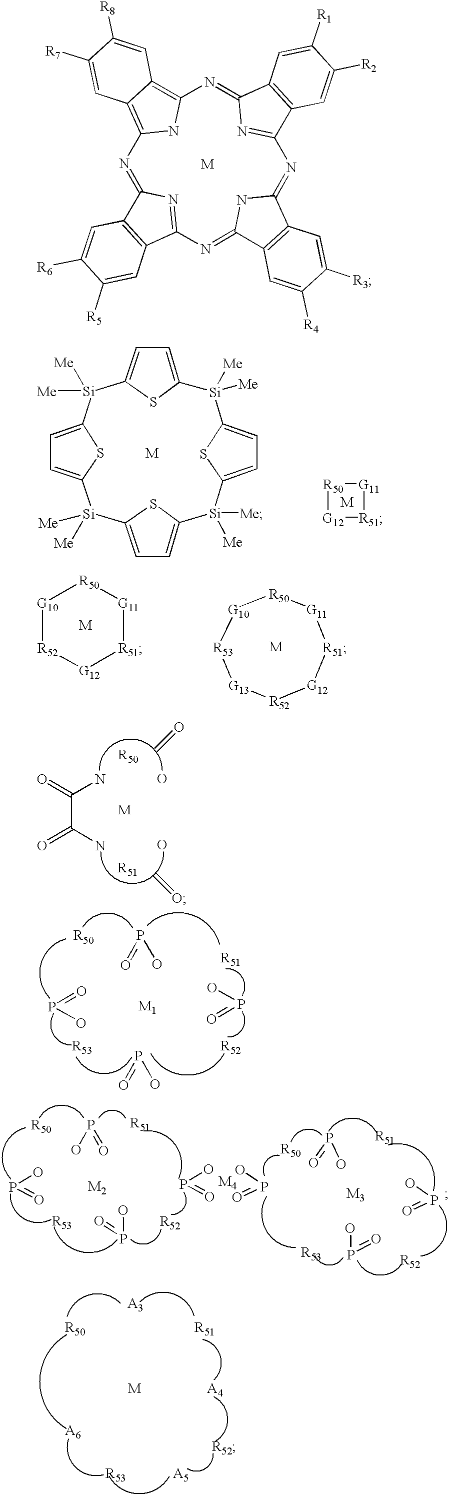

Complexation tendency increases orders of magnitudes in the cage structures disclosed above, which stabilizes the compounds further. The suitable metals within the cages are isolated from each other, which also provides a higher fluorescence lifetime. Inter-complexation is reduced or even eliminated, increasing the solubility of the complex in a solvent and/or a polymer matrix.

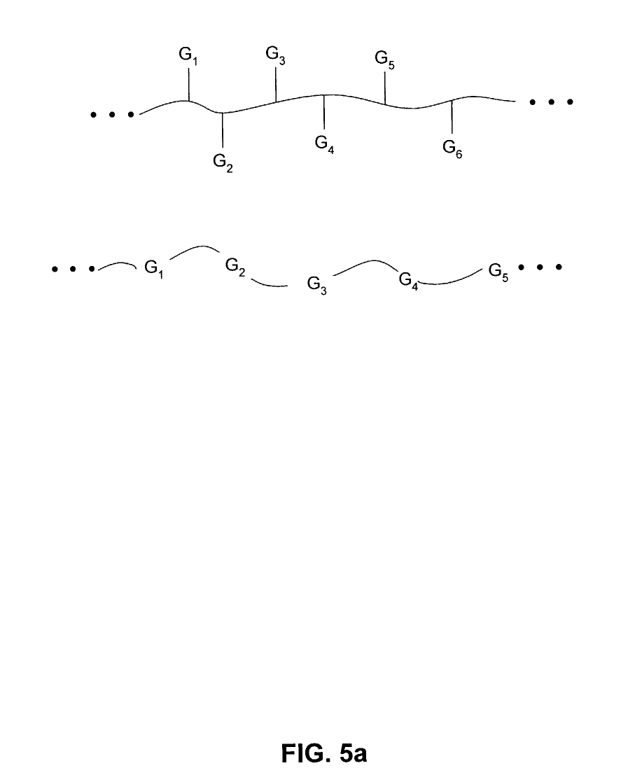

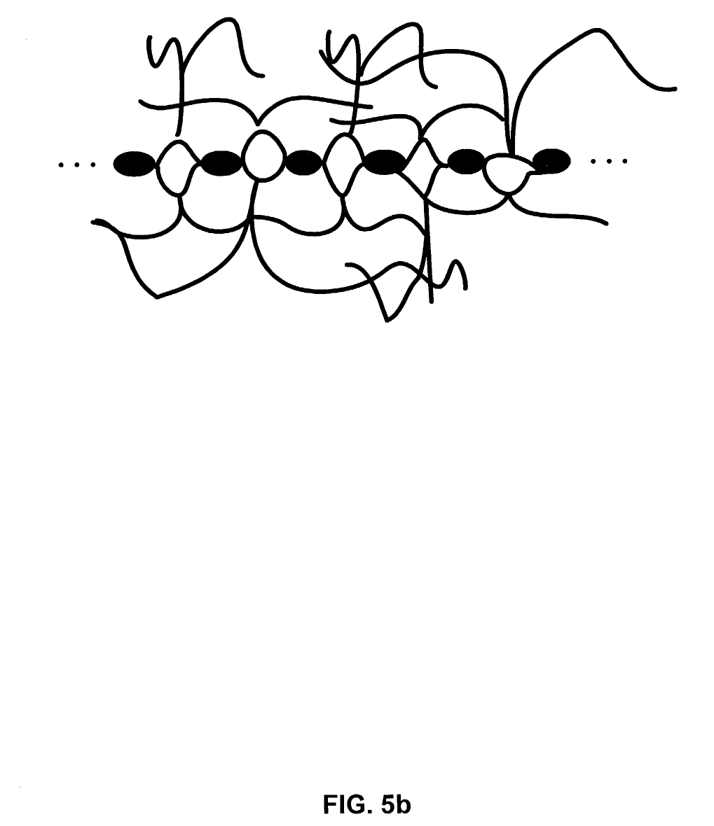

FIGS. 5a and 5b show other illustrative polymers of the present invention. FIG. 5a shows polymers with side chain and backbone incorporation of groups (Gᵢ) which can coordinate with one or more suitable metals. FIG. 5b shows complexes of suitable metals with polymer entities. The solid ovals represent suitable metals and the lines represent cross-linked, branched, dendritic, or amorphous polymer chains that include monomers of coordinating groups throughout. In an exemplary embodiment of FIG. 5b, the density of coordinating groups can be higher near the suitable metals.

The structures of the polymers shown in FIGS. 5a and 5b, and others, of the present invention can be random to prevent crystallization.

Any of the complexes of the present invention can be mixed with polymer matrices including perfluoropolymers, poly[2,3-(perfluoroalkenyl)perfluorotetrahydrofuran], poly[2,2-bistrifluoromethyl-4,5-difluoro-1,3-dioxole-co-tetrafluoroetliylene], poly[2,2,4-trifluoro-5-trifluoromethoxy-1,3-dioxole-co-tetrafluoroethylenel, fluoropolymers, tetrfluoroethylene/hexafluoropropylene/vinylidene copolymers known as THV® (3M), fluorinated polyimides, fluorinated acrylates, fluorinated methacrylates, fluorinated polyarylethers, high quality optical polymers, halogenated polymethylmethacrylate, halogenated polystyrene, halogenated polycarbonate, halogenated norbornene polymers. Perhalogenated alkoxys, perhalogenated thioalkoxys, perhalogenated aryloxys, perhalogenated polyethers, or perhalogenated polythioethers as polymers or solvents can also be mixed with complexes of the present invention.

Ionic complexes listed above can be combined with other, oppositely charged, ionic complexes described above or other oppositely charged, ionic complexes not described herein to form additional complexes. For these complexes, the suitable metal connected to the negative ionic complex can be the same as or different from the suitable metal connected to the positive ionic complex. For the above-listed ligands and complexes, where hydrogen (H) is typically present, the H can be replaced with a halogen, and in one embodiment, fluorine.

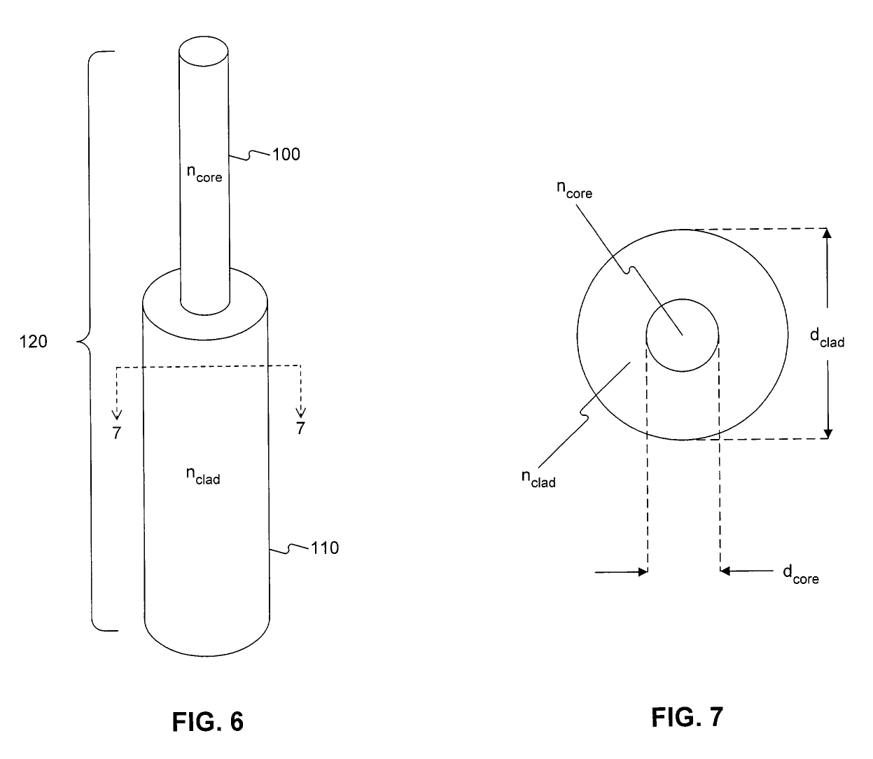

As shown in FIGS. 6 and 7, the above-identified compositions may be used, for example, to produce cores for optical fibers. The cores can be cladded with any suitable material having a lower refractive index than the core. In some cases, the core/cladding refractive index difference and core diameter can be enough to result in single optical mode propagation for optical wavelengths from about 1200 nm to about 1700 nm.

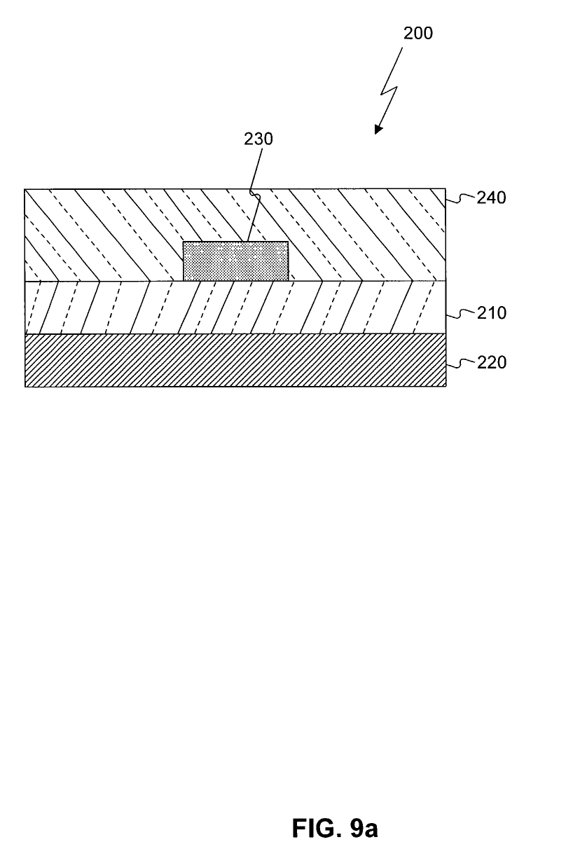

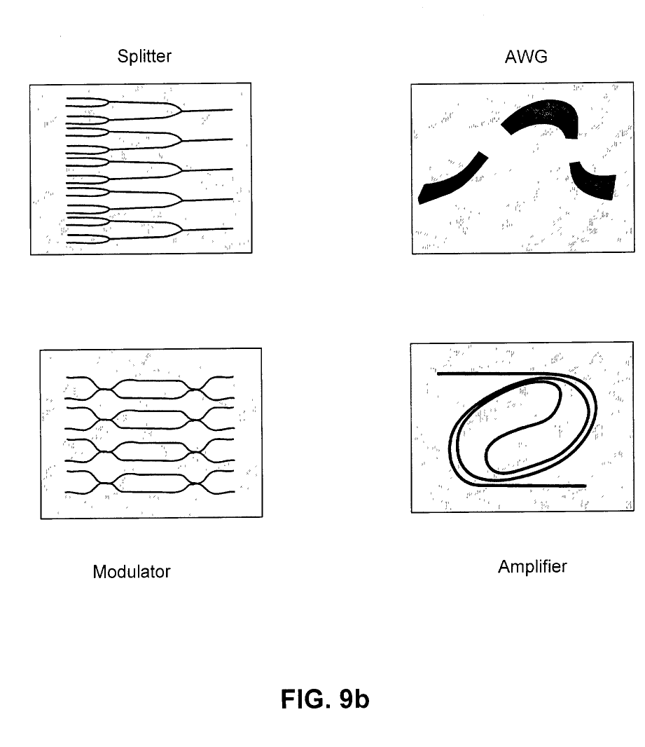

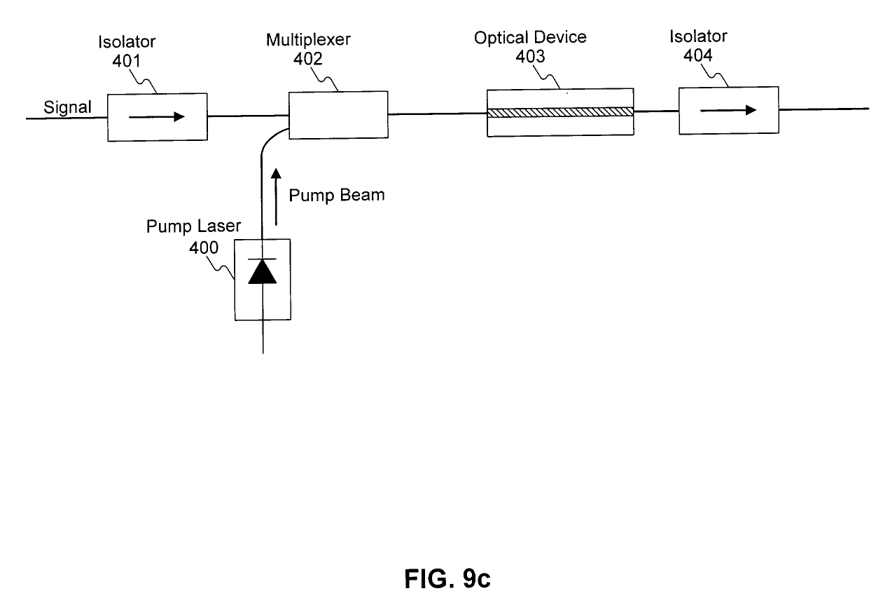

Also as shown in FIG. 9a, the compositions identified may be used to produce optical amplifying film 200, which can include substrate 220, buffer film 210 disposed on substrate 220, wave guiding layer 230 disposed on buffer film 210, and upper cladding film 240 disposed on guiding layer 230. The refractive indices of buffer film 210 and upper cladding film 240 can be less than that of guiding layer film 230. In some embodiments, wave guide layer 230 can guide a single optical mode of light having a wavelength between about 1200 nm and about 1700 nm.

The suitable metal doped halogenated complexes can incorporate suitable metal atoms in a covalently bonded complex chain. In certain exemplary embodiments, deleterious effects, such as clustering and upconversion quenching, are reduced. Certain exemplary embodiments of the present invention use selected energy transfer suitable metal ion codopants that increase the overall absorption for pumping radiation and can transfer that absorbed radiation to suitable metal ions that luminescence at wavelengths of interest. These codopants can be incorporated at a continuum of desired levels, providing for more precise control over the ratio of codopant ions to luminescing ions. To obtain particular optical gain, the complex composition can be tuned to optimize absorption of the pump radiation, luminescence efficiency, and noise level. For example, concentrations of codopant and luminescing suitable metal ions can be incorporated (up to about 5-15%) leading to a very high gain per unit length, resulting from increased pump absorption and/or efficient luminescence. In certain exemplary embodiments, the complex medium provides a broader gain spectrum than glass media, owing to nonhomogeneous broadening, thereby leading directly to a broader band amplifier or gain medium.

The codopant complexes of some embodiments consistent with this invention are made via a condensation type of polymerization in inert solvents for example, lower alkyl ketones, lower alkyl ethers, or acetone.

The salt of a perhalogenated substituted acid (and in some exemplary embodiments, phosphinic acid) may be added to a mixture of suitable metal halides, M₁X₉, M₂X₁₀, M₃X₁₁, and M₄X₁₂, where M₁, M₂, M₃, and M₄ are the same or different and are chosen from the suitable metals as defined herein, and X₉, X₁₀, X₁₁, and X₁₂ can be the same or different and are halides as defined herein. Five or more suitable metals can be used. The counterion of the deprotinated acid can be Na, K, NH₄, Rb, Cs, Be, Mg, Ca, Sr, Ba, or any cation suitable for the reaction. The solid that results is stirred for up to about 72 hours (or up to about 48 hours, or up to about 2 hours, or up to about 1 minute, or any amount of time needed to make the desired suitable metal-acid salt) at about room temperature, optionally under nitrogen. Distilled water can then be added to the reaction mixture, which can be boiled to remove the halogen salt by-product, and filtered and washed with boiling water repeatedly. The washed product can then be dried in a vacuum oven. The resultant complexes are soluble in organic solvents, such as dimethyl acetamide and are also usable in high temperature processes.

An alternate method of manufacturing the complex as described above involves mixing precursor phosphinates providing a mixed salt derivative, such as by the reaction:

k(R₁R₂POONa]+l[R₃R₄POONa]+m[R₅R₆POONa]+M→(R₁R₂POO)ₖ(R₃R₄POO)ₗ(R₅R₆POO)ₘM

In one embodiment, k+l+m=3. The molar ratio of total phosphinate to suitable metal can be between about 2.5:1 and about 3.5:1, and in one embodiment the ratio can be about 3.0:1 to enhance solubility. Also, in another exemplary embodiment, R₁, R₂, R₃, R₄, R₅, and R₆ can be the same or different. Differences in these R-groups can produce a random structure, preventing crystallization, as shown in FIG. 5b.

In yet another exemplary embodiment, other suitable metal complexes could be made using one or more of Sc, Cr, Y, La, Ce, Pr, Nd, Pm, Sm, Eu, Gd, Tb, Dy, Ho, or Tm. Other metals, such as Al, Sn, Zn, and other transition metals, such as Ti, Mn, etc . . . , can also form complexes. Any known ligands (including, but not limited to those mentioned herein) could be used to make complexes. The complex formation method could be substantially duplicated using other metal salts, such as Br, I, nitrate, acetate, and any soluble salts.

In one illustrative embodiment, a polar solvent can be used in the formation process. For example, acetone, methanol, water, ethyl ether, methanol, propanol, and acetonitrile have been used successfully in the process. In another embodiment, complex formation with other counterions for the deprotinated acid (such as Na, K, NH₄, Rb, Cs, Be, Mg, Ca, Sr, Ba, or any cation suitable for the reaction) could be used. Although not wishing to be bound by any particular theory, it appears the phosphinic acid or its ammonium salt reacts with metals to form the complexes.

A fiber can be formed from a polymer consistent with this invention. For example, as shown in FIGS. 6-8, a polymer or a blend of the polymer with suitable polymers, such as perfluoropolymers, can be formed into cylindrical rod 100 of first diameter d_{core} and length for example, by molding or extrusion processes. In one embodiment, rod 100 can be inserted into cladding in the form of a tube 110 of a second, lower refractive index material that has a similar processing temperature. Tube 110 can include multiple cladding layers of different optical materials, if desired. Tube 110 has second diameter d_{clad} and is greater than first diameter d_{core}. Tube 110 has refractive index n_{clad} and rod 100 has a refractive index n_{core}.

In general, refractive index n_{clad} of tube 110 is less than refractive index n_{core} of rod 100. In one particular exemplary embodiment, d_{clad} can be at least two times larger than d_{core} for multimode fibers and fifteen times larger for single mode fibers. Tube 110 can be formed from a polymer similar to the polymer which forms rod 100 with a general composition as disclosed above, which may include the suitable metals disclosed as herein.

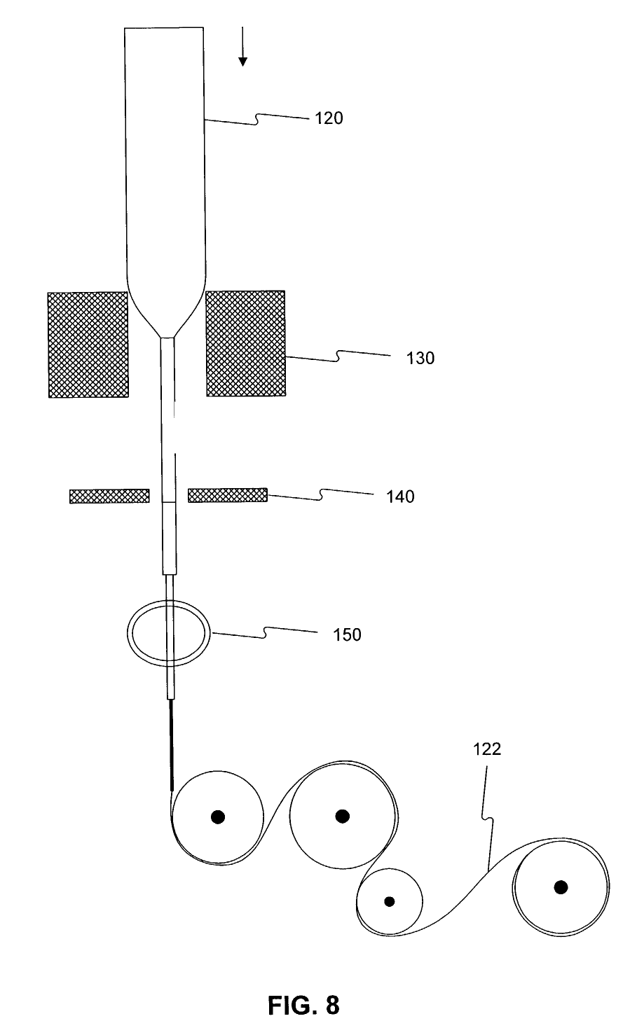

In one embodiment, insertion of rod 100 into tube 110 forms a rod and tube assembly 120. In another embodiment, resulting rod and tube assembly 120 can be, for example, a fiber preform, from which single mode optical fiber can be drawn by standard techniques, such as by melt drawing, which is illustrated in FIG. 8. During operation perform fiber 120 is passed through furnace 130, diameter gauge 140, and coating station 150. It will be appreciated, however, that other drawing techniques can be employed, and this technique is not meant to be limiting. Fiber 122 which is formed from rod and tube assembly 120 can then be installed in an optical amplifier module. During module operation, signal light injected into the module experiences gain while propagating along fiber 122 via transfer of energy from absorbing ions to the emitting ions and subsequent stimulated emission from the emitting ion.

In certain exemplary embodiments, waveguide 200, as shown in FIG. 9 can also be formed from the complex or a blend of the complex with suitable polymers, such as perfluoropolymers. In one illustrative embodiment, the complex, or a blend of the complex with polymers, can be dissolved in a high boiling-point solvent suitable for spin coating or casting. Such a solvent is, for example, FC-40 or FC-75, although those skilled in the art will recognize that other suitable solvents can be used.

As shown in FIG. 9a, bottom cladding material 210 with a refractive index lower than the refractive index of core 230 can be originally deposited on a waveguide substrate 220. A layer of core 230 can be deposited onto bottom cladding material 210, for example by spin coating, although other methods can be used. A photoresistive layer can be deposited over the predetermined portions of core 230. The portions of the core that are not covered by the photoresist layer can be etched away from waveguide 200 by any known method. The photoresistive layer can also be removed from waveguide 200 by any known method, such as by using a solution to form core 230.

Waveguide 200 can be overclad with top cladding material 240, which can have a refractive index lower than the refractive index of the core. In certain exemplary embodiments, the bottom cladding material can be a refractive index approximately equal to the refractive index of top cladding material 240. In one embodiment, bottom cladding material 210 and top cladding material 240 can include the same material, although different materials can be used. In an exemplary embodiment, waveguide 200 can include amplifying properties similar to that of an optical fiber and may be inserted into the optical amplifier module as described above.

FIG. 9b shows a number of simplified diagrams of illustrative embodiments of the integration of waveguide 200 with other optical components consistent with this invention including a splitter, a modulator, an arrayed waveguide grating (herein, “AWG”), and an amplifier. It will be appreciated that other components can also be constructed including, for example, switches, isolators, lasers, fibers, films, and the like.

FIG. 9c shows an optical amplifier module consistent with this invention. Signal light injected into the module will experience gain in the gain medium by transfer of energy from the absorbing chromophore in the ligand to the emitting ion and subsequent stimulated emission from the emitting ion. The gain medium can take the form of a fiber, a film, or any other type of optical waveguide or bulk optical devices. Isolators 401 and 404 prevent back reflections of the signal and amplified signal, respectively. Wavelength division multiplexer 402 combines pump light and signal light, where pump laser 400 provides the pump light. The gain medium which is located in optical device 403, amplifies the signal. The optical amplifier module can then include (a) at least one optical isolator to prevent back reflections, (b) at least one wavelength division multiplexer to combine pump and signal light, (c) a pump laser, and optionally (d) one or more other optical components.

In situ formation of the complexes described above on a substrate to form waveguide 200 as described above provides at least one of the following advantages:

The precursor halogenated-phosphinic acids (HPA) and its partially neutralized salts are exceedingly soluble in perfluorinated hydrocarbon solvents such as FC-75 ( perfluoro n-butyl tetrahydrofuran).

They are also very soluble in solution of halogenated polymers (HP) such as THV, poly[2,3-(perfluoroalkenyl)perfluorotetrahydrofuran], poly[2,2-bistrifluoromethyl-4,5-difluoro-1,3-dioxole-co-tetrafluoroetliylene], poly[2,2,4-trifluoro-5-trifluoromethoxy-1,3-dioxole-co-tetrafluoroethylene], tetrfluoroethylene/hexafluoropropylene/vinylidene, or Kalrez.

The composite films cast from the mixtures of the halogenated polymers and HPAs are very transparent with excellent mechanical properties.

The composite films are allowed to come in contact with the solutions of suitable halides ( or other salts such as nitrate, acetate, etc) in an organic solvent such as acetone.

The complexes are formed after the film deposition, so there is no concern with dissolution.

The complex formation can be further enhanced via neutralization, extraction or azotropic displacement.

Various mixtures of HPAs can be used.

Various mixtures of suitable metals can be utilized for making the complexes.

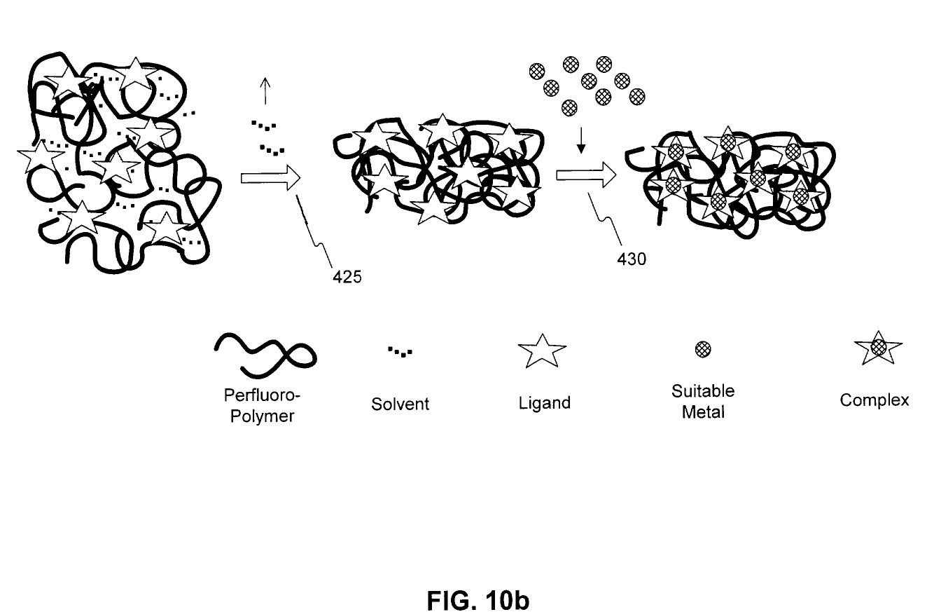

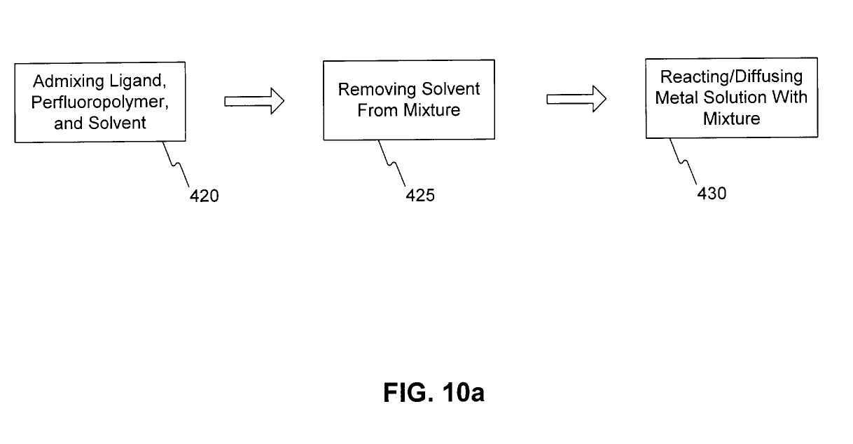

FIG. 10a shows a flow chart of illustrative steps for in situ formation of complexes consistent with this invention. In step 420, a ligand, a perfluoropolymer, and a solvent is admixed to form a mixture. In step 425, the solvent is removed from the mixture. This can be accomplished, for example, by casting a film to increase the surface area of the mixture. This achieves a substantially uniform distribution of ligands within the mixture with little or no aggregation. In step 430, a suitable metal solution is applied to the film. The metal solution reacts (e.g., diffuses) with the film and allows for the exchange of the metal ions with active sites within the film. The reaction thus achieves a substantially uniform distribution of metal ions within the mixture with little or no aggregation.

As shown in FIG. 10b, a mixture is formed with the active precursor HPA, HP, and the solvents as a result of step 420. In step 425, a uniform clear film can be cast on the substrate (or on the cladding surface) for removal of the solvent. Optimization may be necessary to partially dry the solvent for improved transport/diffusion of the metal ion. In step 430, a suitable metal solution (e.g., including dry acetone), is applied to the film and allowed to equilibrate therewith, which results in metal diffusion within the mixture. When forming a film, it will be further appreciated that conventional chip processing steps, including photolithographic steps, can be performed to obtain a final optical device, including, for example, applying photo-resistive layers, masking, exposing to light, etching (e.g., reactive ion etching), etc. These steps can be followed by applying one or more cladding layers. Alternatively, ion exchange can be performed after a chip manufacturing process and before application of the cladding and packaging materials.

An Exemplary Method for Preparing an Optical Gain Medium

In an exemplary embodiment, a method for preparing a gain medium includes (a) admixing a composition comprising at least one complex with at least one suitable solvent DMAC, FC-75, CT Solv 180 (perfluorotrialkylamine, CAS No. 865-08-42-1), CT Solv 100, CT Sol 130 and any combination thereof.

In step (b), heating can occur in the range of about 50° C. to about 150° C. for about 5 minutes to about 2 hours. Alternately, heating can occur in the range of about 60° C. to about 90° C. or at about 100° C. In another embodiment, heating can be for about 10 minutes to about 30 minutes.

In step (c), cooling can occur to in the range of about 20° C. to about 30° C. In other exemplary embodiments of this method, the cooling in step (c) can be to about 25° C. or to about room temperature.

In step (d), admixing can occur with a perfluoropolymer to produce a mixture. The perfluoropolymer can be cyclopolymerized perfluoro-vinyl ether, copolymers of 2,2-bistrifluoromethyl-4,5-difluoro-1,3 dioxole (PDD) with other suitable monomers, cyclic polyethers prepared from cyclopolymerization of fluorine-containing dienes as described in U.S. Pat. No. 4,897,457, which is hereby incorporated by reference, and polymer and copolymers of 2,2,4-trifluoro-5-trifluoromethoxy-1,3-dioxole and other analogues as described in U.S. Pat. No. 5,498,682, which is hereby incorporated by reference, with other suitable monomers.

In another embodiments the perfluoropolymer can be a 16% (wt/wt) amorphous cyclopolymerized perfluoro-vinyl ether in a perfluoroether solvent.

In step (e), the mixture can be formed into a gain medium. Forming in step (e) can include filtering using about 0.45 or about 0.2 micron filters. In another embodiment of this method, the forming can include drying for about 1 to about 50, hours or for about 5 hours to about 10 hours at a temperature of about 100° C. to about 150° C. or about 130° C. The forming in step (e) can also include casting, film casting, spin casting, film coating, and/or any other method for forming a gain medium into a desirable form that is known to those of ordinary skill in the art. For example, forming in step (e) can include depositing the mixture on a substrate, such as a silicon wafer.

In an exemplary embodiment, an optical device can be produced from the gain medium using methods known to those of ordinary skill in the art. Illustrative optical devices including optical fibers, waveguides, AWGs, films, amplifiers, lasers, multiplexers, isolators, interleavers, demultiplexers, filters, photodetectors and switches.

### EXAMPLE 1

Preparation of the Na salt of (n-C₈F₁₇)₂POOH (dioctyl-perfluoro-phosphinic acid): Three grams (3.32 mmole) of (n-C₈F₁₇)₂POOH was added to 17 ml of methanol and dissolved by stirring with a magnetic stir bar. A NaOH solution was prepared by dissolving 0.133 gram (3.32 mmole) of NaOH in 17 ml of distilled water. This NaOH solution was added to the methanol-phosphinic acid mixture. The pH was adjusted to 7.00 by adding slight excess of phosphinic acid or NaOH, as needed. The solution was filtered and then dried on a warm hot plate. The Na salt of the phosphinic acid was further dried in a vacuum oven at 70° C. overnight before use.

Preparation of Complex: In this example we report preparation of Er[(n-C₈F₁₇)₂POO]₃. Na[(n-C₈F₁₇)₂POO] (0.447 g, 0.4838 mmole) was dissolved in 6 ml of acetone in a 30 ml vial. The ErCl₃ (0.04417g, 0.1613 mmole) was dissolved in 2 ml of acetone (reagent grade, Fisher). The ErCl₃ solution was added to the Na[(n-C₈F₁₇)₂POO] solution all at once while mixing with a magnetic stir bar. The container of the ErCl₃ was rinsed 3 times with 1.5 ml of acetone and the rinsings added to the 30 ml reaction vial. Immediately a fluffy precipitate formed which stuck to the side of the vial. The vial was heated to boil (100° C.), then cooled to room temperature. The reaction vessel was left overnight and then 15 ml of distilled water was added and heated to boil for five minutes and then cooled to room temperature. The precipitate was filtered and dried in vacuum oven at 80° C. overnight. The weight of the product was 0.4247 g. The lifetime of this complex was 1.8 ms.

### EXAMPLE 2

In this example we report preparation of a complex of Er, Yb and (n-C₈F₁₇)₂POO. The molar ratio of the Er to Yb in the complex is 1:1 and the ratio of the metal to the phosphinic acid is 1 metal/3 (n-C₈F₁₇)₂POO⁻. Na[(n-C₈F₁₇)₂POO] (1.08 g, 1.08 mmole) was dissolved in 14 ml of dry acetone and a solution of 0.049 g ErCl₃ and 0.050 g YbCl₃ in 1.4 ml dry acetone was added. The reaction mixture was stirred under N₂ for about 2 hours. The solution was boiled briefly and then filtered. The residue was washed with 50 ml of warm deionized water and dried in vacuum oven overnight. We obtained 0.80 grams of product (77% yield). The lifetime of this complex was 4.5 ms.

### EXAMPLE 3

In this example the complex stoichiometry of (n-C₈F₁₇)₂POO⁻ to total metal (Er+Yb) is 1.0/0.9 (i.e., 10% excess phosphinate). The molar ratio of Er to Yb is 1:4. Ten ml of dried acetone was added to dissolve 0.9993 g (1.0815 mmole) of Na[(n-C₈F₁₇)₂POO]. The Na[(n-C₈F₁₇)₂POO]-acetone solution was added over 1 minute to a 2 ml solution of 17.7 mg of ErCl₃, 75.4 mg YbCl₃ in acetone. Precipitate formed immediately. The container of the metal chloride solution was rinsed twice with 1.5 ml of additional acetone and transferred to the reaction container. The reaction container was purged with N₂ overnight. Eighteen ml of hot deionized water was admixed and heated to boil. Precipitate was filtered and washed with additional 20 ml of hot water. We obtained 0.8739 gram (84.3% yields) of product after vacuum drying at 80° C. in a vacuum oven overnight. This product had a lifetime of 5.1 ms.

### EXAMPLE 4

This example describes a synthesis of a complex of [n-C₆F₁₃]₂POOH with Er and Yb salt where the Er to Yb molar ratio is 1:1.

Preparation of sodium salt: [n-C₆F₁₃]₂POOH (1.00 g, 1.42 mmole) was dissolved in 7.5 ml of methanol. This methanol solution was added to 0.057 g (1.42 mmole) of NaOH in 7.5 ml of deionized water. The pH was adjusted to 7.0 by addition of few drops of NaOH. The solution was filtered and dried over a warm hot plate. The powder was dried in a vacuum oven at 40° C. for two days. We obtained 868 mg (84.2% yields) of white powder.

Preparation of complex: To a solution of 49 mg ErCl₃ and 50.9 mg YbCl₃ in 1 ml acetone was added 785 mg (1.08 mmole) Na([n-C₆F₁₃]₂POO) in 11 ml of acetone. After 2 hours of continuous stirring under N₂, 11 ml of deionized water was added. The mixture was heated to boil, filtered and washed with 50 ml of deionized water. The residue was dried in a vacuum oven overnight at 80° C. The reaction yielded 0.56 g of product (68.3% yields). The lifetime of the product was 4.0 ms.

### EXAMPLE 5

In this example, the phosphinic acid is ((CF₃)₂CF—O—CF₂CF₂)₂POOH. The phosphinic acid was purified by fractional sublimation. The fraction used for this work was collected at a temperature range of 120° C. to 170° C. at a vacuum of >5 m torr. Phosphorus-31 NMR indicated that the material was >75% phosphinic and the remainder phosphonic acids.

Sodium salt formation and complex: ((CF₃)₂CF—O—CF₂CF₂)₂POOH (0.85 gram) was dissolved in 8.61 g methanol and then added to 1.161 g of 1% NaOH in methanol. Additional NaOH was added to adjust the pH to about 6. A solution of 5.6 mg ErCl₃ and 21.7 mg YbCl₃ in 1.5 ml of acetone was added dropwise over 1 minute to the solution of Na[((CF₃)₂CF—O—CF₂CF₂)₂POO]. Initially no precipitate was observed, but after heating at 50° C. for 2 hours, some precipitate was obtained which was filtered and washed with small amount of water and then dried. We obtained 158.4 mg of product and measured a lifetime of 3.2 ms.

### EXAMPLE 6

In this example we report metal salts of the phosphinic acid, (n-C₄F₉)₂POOH, where the molar ratio of the Er to Yb is 1:1.

Preparation of sodium salt: After dissolving sublimed (n-C4F9)2POOH (2.25 g, 4.48 mmole) in 24 ml of methanol, 0.18 g (4.48 mmole) of NaOH was added and the pH adjusted to 7.0. The solution was dried on a warm plate and left overnight in a vacuum oven. We obtained 2.28 g of solid (97% yield).

Preparation of complex: One gram (1.9 m mole) of Na[(n-C₄F₉)₂POO] was dissolved in 25 ml of acetone and then added a solution of 87 mg ErCl₃ and 89 mg of YbCl₃ in 2 ml of acetone. The reaction mixture was stirred under N₂ for two days. Then it was boiled and filtered. The product was dried in a vacuum oven resulting in 800 mg of complex (75% yield). The lifetime of this product was 2.0 ms.

In the next examples, phosphinic acids and a thiophosphinic acid are converted to sodium salt and then Er/YB complexes (1 :3 mole ratio) are prepared. See Table 1 for properties.

### EXAMPLE 7

((CF₃)₂CF(CF₂)₆)₂POOH (1.012 gram, 0.9792 mmole) was dissolved in 6 ml of methanol, followed by the addition of 3.92 g of 1% wt/wt NaOH solution in methanol. The pH of the solution was adjusted to fall in the range of about 6.0 and about 7.0 by admixing 0.15 g of 1% NaOH in methanol. ErCl₃ (22.3 mg) and YbCl₃ (68.4 mg) were combined and dissolved in 1 ml of methanol. The solution of ErCl₃ and YbCl₃ was added over 30 seconds to the stirring Na[((CF₃)₂CF(CF₂)₆)POO] solution. A white precipitate was formed immediately. The reaction mixture was heated to boiling for 5 minutes, cooled to room temperature and then kept overnight. After drying with a gentle stream of N₂, the precipitate was re-suspended in 10 ml of acetone. Ten ml of deionized water was added to remove NaCl. The crystals were filtered the next day, washed 3 times with warm deionized water and dried in a vacuum oven at 70° C. overnight to yield 0.978g of product.

### EXAMPLE 8

((CF₃)₂CF(CF₂)₆)₂PSOH (0.5078 gram, 0.4763 mmole) was dissolved in 5 ml of methanol, followed by the addition of 1.93 g of 1% wt/wt NaOH in methanol. The pH of this solution was 10.5 after the NaOH addition; the pH was not adjusted. ErCl₃ (10.7 mg) and YbCl₃ (33.3 mg) were combined and dissolved in 1 ml of methanol. The ErCl₃ and YbCl₃ solution was added over 30 seconds to the stirring NA[(((CF₃)₂CF(CF₂)₆)PSO] solution. An oily white residue formed and adhered to the bottom and the side of the reaction vessel. The reaction mixture was heated to boiling in 5 minutes, then cooled to room temperature and kept overnight. The solution was dried with a gentle stream of N₂. To remove NaCl, the oily residue was treated with a mixture of 10 ml of acetone and 10 ml of deionized water. The acetone/water aliquot was decanted the next day and the oily-looking residue was washed 3 times with warm deionized water and dried to yield 0.470 g of product.

### EXAMPLE 9

(n-C₁₀F₂₃)₂POOH (253.7 mg, 0.2237 mmole) was dissolved in 8 ml of methanol followed by the addition of 0.895 g 1% wt/wt NaOH in methanol. The pH of the solution was 7.0. ErCl₃ (5.1 mg) and YbCl₃ (15.6 mg) were combined and dissolved in 1 ml of methanol. The ErCl₃ and YbCl₃ solution was added over 30 seconds to the stirring Na[(n-C₁₀F₂₃)₂POO] solution. A white precipitate was formed immediately. The reaction mixture was heated to boiling in 5 minutes, cooled to room temperature and kept overnight. The solution was dried with a gentle stream of N₂. To extract NaCl, the precipitate was re-suspended in a mixture of 5 ml of acetone and 5 ml of deionized water. The crystals were filtered the next day, washed 3 times with warm deionized water, and dried to yield 0.239 of product.

### EXAMPLE 10

(n-C₈F₁₇)(n-C₁₀F₂₃)POOH (0.5582 gram, 0.5398 mmole) was dissolved in 8 ml of methanol, followed by the addition of 2.159 g 1% wt/wt NaOH in methanol. The pH of the solution was adjusted to fall in the range of about 6.0 and about 7.0 by adding 0.27 g of 1% NaOH in methanol. ErCl₃ (12.3 mg) and YbCl₃ (37.7 mg) were dissolved in 1 ml of methanol. The ErCl₃ and YbCl₃ solution was added over 30 seconds to the stirring Na[(n-C₈F₁₇)(n-C₁₀F₂₃)POO] solution. A white precipitate was formed immediately. The reaction mixture was heated to boiling for 5 minutes, cooled to room temperature and kept overnight. The solution was dried with a gentle stream of N₂. To remove NaCl, the precipitate was re-suspended in 6 ml of acetone and 6 ml of deionized water. The crystals were filtered the next day, washed 3 times with warm deionized water, and dried to yield 0.535 g of product.

TABLE 1
Composition and Lifetime for Various Phosphinic and
Thiophosphinic Acid Complexes

| | | Molar Ratio of | Lifetime |
|---|---|---|---|
| Example # | Phosphinic Acid | Er/Yb | (ms) |
| 1 | (n-C₈F₁₇)₂POOH | Er only | 1.8 |
| 2 | (n-C₈F₁₇)₂POOH | 1/1 | 4.5 |
| 3 | (n-G₈F₁₇)₂POOH | 1/4 | 5.1 |
| 4 | (n-C₆F₁₃)₂POOH | 1/1 | 4.0 |
| 5 | (i-C₃F₇OC₂F₄)₂POOH | 1/4 | 3.2 |
| 6 | (n-C₄F₉)₂POOH | 1/1 | 2.0 |
| 7 | ((CF₃)₂CF(CF₂)₆)₂POOH | 1/3 | 4.6 |
| 8 | ((CF₃)₂CF(CF₂)₆)₂PSOH^{a} | 1/3 | <1^{c} |
| 9 | (n-C₁₀F₂₃)₂POOH | 1/3 | 4.6 |
| 10 | (n-C₈F₁₇)(n-C₁₀F₂₃)POOH^{b} | 1/3 | <1^{c} |

^{a}A thiophosphonic acid
^{b}Mixed fluorinated hydrocarbons on phosphinic acid
^{c}Lifetime too short to measure accurately using our equipment

In examples 11-13, we demonstrate the effect of the relative concentration of phosphinic acid (e.g., R₁R₂POOH) to phosphonic acid (e.g., R₁PO(OH)₂) on the fluorescence life time of a 1:4 Er:Yb complex.

### EXAMPLES 11, 12 AND 13

The desired mixtures of phosphinic/phosphonic acid were prepared by fractional sublimation of (n-C₈F₁₇)₂POOH. In the fractional sublimation procedure, about 0.5 g of partially purified (n-C₈F₁₇)₂POOH was placed in an open container at one end of a 1 cm diameter by 50 cm long sealed glass tube. The sealed glass tube was then evacuated to about 2 mtorr and heated to produce a temperature gradient profile, wherein the temperature at the boat was 180° C. and the temperature at the end opposite the boat was room temperature. The latter end of the tube was attached to the vacuum system. After allowing sublimation for 24 hrs, the tube was removed and cut into 1 cm segments. The samples used in examples 11,12 and 13 were collected in temperature zones corresponding to average temperature of 130° C., 115° C. and 105° C., respectively. The relative amount of phosphinic and phosphonic in the samples were determined using ³¹P NMR. The samples were converted to Er/Yb complexes in a manner similar to that described in Examples 7-10.

TABLE 2
Effect of Mole Percent of Phosphinic and Phosphonic Acid on the
Lifetime of Er/Yb Complexes

| | Mole % of | Mole % of | Molar | |
|---|---|---|---|---|
| | Phosphinic Acid | Phosphonic Acid | Ratio of | Lifetime |
| Example # | (n-C₈F₁₇)₂POOH | (n-C₈F₁₇)PO(OH)₂ | Er/Yb | (ms) |
| 11 | 100 | 0 | 1/4 | 4.8 |
| 12 | 75 | 25 | 1/4 | 4.0 |
| 13 | 20 | 80 | 1/4 | <1^{a} |

^{a}Lifetime too short to measure accurately by our equipment.

As shown in Table 2, the pure phosphinic acid has the highest lifetime (4.8 ms), the sample containing 25 mole % phosphonic acid has somewhat lower fluorescence lifetime (4.0 ms) and sample containing 80% phosphonic derivative has a lifetime too short to measure by our equipment (<1 ms).

### Comparative Example 14

In this example, the lifetime of commercial sample of ErFOD, a complex containing both fluorocarbon as well as hydrocarbon moieties was measured. The ErFOD chemical structure is Er [(CH₃)₃C—(CO)—CH₂—(CO)—CF₂CF₂CF₃]₃.

This complex has a lifetime of about 1.5 ms. ErFOD has very good solubility and therefore could be compounded into many matrices including perfluoro as well as partially fluorinated resins.

### Film Preparation and Evaluation

Table 3 gives two examples of composite films in a perfluoropolymer matrix. The active loadings are 20% and 34% (by wt), respectively. These examples show that we can achieve high concentrations of active materials in fluoropolymers with high fluorescent lifetimes.

### Film Example 15

To 101.9 mg of the complex prepared in example 2 (ErYb[(n-C₈F₁₇)₂POO]₆) was added 13.2 μliter of dimethylacetamide (DMAC) and 13.2 μiter of FC 75 (perfluoro n-butyl tetrahydrofuran) and 1.73 g of a CT Solv 180. The mixture was heated to 100° C. with stirring until it became clear in 10-30 minutes. The solution was cooled to room temperature and 1.23 g of 16% (wt/wt) amorphous cyclopolymerized perfluoro-vinyl ether in a perfluoroether solvent was added. The resulting clear solution was filtered through a 0.45 micron filter and spin cast on a silicon wafer. After drying for 5-10 hours at 130° C., it was removed and the fluorescence lifetime was measured. Other substrates known to those of ordinary skill in the art can be used.

### Film Example 16

In this example, appropriate quantities of Er phosphinic complex and Yb phosphinic complex were dissolved in a perfluorosolvent solution containing perfluoropolymer. DMAC (16.7 μliter) and 3.24 g of the CT Solv 180 were added to 25.9 mg of Er[(n-C₈F₁₇)₂POO]₃ and 103.5 mg of Yb[(n-C₈F₁₇)₂POO]₃. The mixture was heated to 60-90° C. with stirring. After dissolution, 3.33 g of 16% (wt/wt) amorphous cyclopolymerized perfluoro-vinyl ether in a perfluoroether solvent was added was added with stirring. The solution was filtered (0.45 Micron) and film cast on a silicon wafer. The film was dried as above and the lifetime was measured. Other substrates known to those of ordinary skill in the art can be used.

TABLE 3
Lifetime of a Composition of a Perfluorofilm Containing Phosphinic
Acid Complexes

| Film | | Concentration of | |
|---|---|---|---|
| Example | | Active Form(wt %) | Lifetime |
| # | Active Form | in Solid Film^{a} | (ms) |
| 15 | ErYb[(n-C₈F₁₇)₂POO]₆^{b} | 34% | 2.1 |
| 16 | ErYb₄[(n-C₈F₁₇)₂POO]₁₅^{c} | 20% | 3.8 |

^{a}Solution concentration is 10 wt % solid before spin coating
^{b}This designates a phosphinic acid complex with Er/Yb 1/1 molar compositon using [(n-C₈F₁₇)₂POO].
^{c}This was made by dissolving individual Er phosphinic acid and Yb phosphinic acid derivatives to make the solution; the phosphinic acid used was [(n-C₈F₁₇)₂POO].

### EXAMPLE 17

### Fluorescence Lifetime Measurements

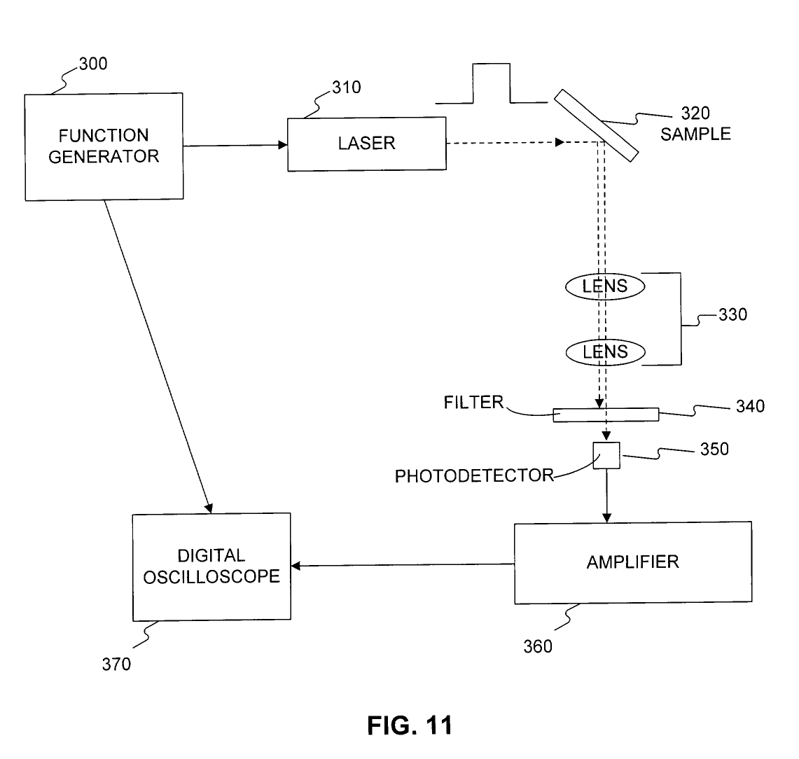

The fluorescence lifetime measurements can be performed using any suitable fluorescence spectrometer using any suitable technique. The measurements reported here were performed using the experimental set-up shown in FIG. 11. Laser 310 (980 nm diode laser) was modulated by function generator 300 (WaveTek Model 275) to give a square wave pulse of amplitude 0.5 V and frequency of 10 Hz. The pump beam generated by laser 310 was expanded before being incident on sample 320, and the resulting fluorescence signal generated was expanded and collimated using lenses 330. The collimated pulsed beam was then directed toward semiconductor photo-detector 350 after passing through 1550 nm narrow band filter 340 to block reflected pump light. The signal from the photo-detector was amplified with a Model 101C Transimpedance amplifier 360, and the amplified signal was collected by a Tektronix TDS 3032 digital oscilliscope 370 upon being triggered by the trigger signal from the function generator. The metastable state lifetime (τ) was determined by fitting the averaged fluorescence signal (I(t)) to a single exponential decay, I(t)=α+β*exp(−t/τ), where α and β are constant.

### EXAMPLE 18

### ³¹P NMR Experiments

The NMR experiments can be performed using any suitable probe, magnetic field, and NMR instrument. NMR experiments were recorded at 30° C. on a Bruker DRX 500-MHz spectrometer equipped with a Broadband Observe (BBO), z-axis gradient probe. One dimension ¹H NMR experiments were collected with a 7.5 kHz spectral width and 32k complex data points. One dimension ³¹P NMR experiments were collected with a 40 kHz spectral width and 32 k complex data points. One dimension ¹⁹F NMR experiments were collected with a 100 kHz spectral width and 128 k complex data points. All NMR data were processed using XWIN NMR program (Bruker).

Other exemplary embodiments of the invention will be apparent from consideration of the specification and practice of the invention disclosed herein. It is intended that the specification and examples be considered as exemplary only, with a true scope and spirit of the invention being indicated by the following claims.

What is claimed is:

1. A composition comprising at least one suitable metal is selected from aluminum (Al), chromium (Cr), scandium (Sc), yttrium (Y), lutetium (Lu), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm) and ytterbium (Yb);
at least one first ligand; and
at least one second ligand,
wherein
the at least one first ligand is selected from 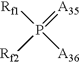
where
A₃₅ is selected from O and S;
A₃₆ is selected from —OH, —SH, and —OR₈₀;
R_{f1}, and R_{f2} can be the same or different, can be branched or unbranched, can be linked to form cyclic or extended structures, and are selected from halogenated alkyl, halogenated aryl, halogenated cyclic alkyl, halogenated arylalkyl, halogenated alkylaryl, halogenated ether, halogenated thioether, halogenated ether thioether, halogenated aklyl amino groups, halogenated alkylene, halogenated silylene, halogenated siloxanes, halogenated silazanes, halogenated olefins, fluorinated alkyl, fluorinated aryl, fluorinated cyclic alkyl, fluorinated arylalkyl, fluorinated alkylaryl, fluorinated ether, fluorinated thioether, fluorinated ether thioether, fluorinated aklyl amino groups, fluorinated alkylene, fluorinated silylene, fluorinated siloxanes, fluorinated silazanes, fluorinated olefins, branched perfluorinated C₁₋₂₀ alkyl, unbranched perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)2CFO(CF₂)₂; and
R₈₀ can be branched or unbranched and is selected from C₁₋₆ alkyl, C₁₋₁₅ alkyl, C₃₋₁₅ aryl, C₄₋₁₅ alkylaryl, and C₄-15 arylalkyl.

2. The composition of claim 1 wherein said composition is an optical composition.

3. The composition of claim 1 wherein said at least one second ligand is selected from:
benzoyl acetonate; dibenzoyl methane; 1,1,1-trifluoro-2,4-pentanedion; 1,1,1,5,5,5-hexafluoro-2,4-pentanedion; 2,2′-bipiperazine ; 2,4-pentanediamine; picolylamine; 1,8-naphthyridine; tris(2-pyridylmethyl)amine; salicylidene aminate; N,N′-disalicylidene ethylenediamine; N-salicycildene cyclohexyl aminate; 1,1,1,3,5,5,5-heptafluoro-2,4-pentanedion; 1,1,1,5,5,5-hexafluoro-3,3-deutero-2,4-pentanedion; thenoyl trifluoroacetonate; 1,1,1,5,5,6,6,6-octafluoro-2,4-hexanedion; 1,1,1,5,5,6,6,7,7,7-decafluoro-2,4-heptanedion; pentafluorobenzoyl trifluoroacetonate; bis(pentafluorobenzoyl)methane; pentadecafluorooctanoic acid; N,N′-disalicylidene-1,2-cyclohexylenediamine; acetyl; acetylacetonate (CH₃COCHCOCH₃); 2,2′-dipyridine; benzyl; cycloocta-1,5,-diene; cyclooctatetraene; cyclopentadienyl; benzene; pentamethylcyclopentadienyl; cyclohexyl; dibenzylmethyl; dimethoxyethane; N,N′-dimethylformamide; 1,2-bis(dimethylphosphino)ethane; 1,2-bis(dimethylphosphino)methane; ethane-1,2-dithiolate; C₆H₄(C₂H₅)COCHCOC₆H₄(C₂H₅); hexamethylphosphoric triamide; toluene; 2,4,6-trimethylphenyl; NC₆H₄CH₃; neopentoxide; benzoate; CH₃C₆H₄CO₂; oxalate; phenyl; phthalic acid; picolinate; pyridine; pyrazole; salicylaldehyde; tolyl; triflate; 1,4,7,10,13,16-hexaoxacyclooctadecane; glycine; alanine; valine; leucine; isoleucine; methionine; phenylalanine; tryptophane; serine; threonine; asparagine; glutamine; aspartic acid; glutamic acid; cysteine; tyrosine; histidine; lysine; arginine; adenine; cytosine; uracil; guanine; thymine; oxygen; halogen; hydroxyl; carbon monoxide; water; C₆H₄O₂; C₆H₁₂O₂; —OC₄H₉; —OC₃H₇; —OCH₃; —C₇H₄O₃; —C₅H₇O₂; —OOC₅H₄N; —CH₃; —C₃H₇; —C₄H₉; carbanyldicyanomethanide; 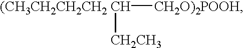
5,10,15,20-tetraphenyl porphyrin; 2,6diaminopyridine; polymers made from O₂CCH₂CO₂; polymers made from diberzoylmethane; fluorescein; —P(OCH₃)₃; R₁CH(SO₂R_{f})₂; fluorocarbon acid; triphenylphosphine; Me₃P; ⁿBu₃P; CH₃CN; PEt₃; P(OPh)₃; tetramethylethyldiamine; FSbF₅; FBF₃⁻; OPOF₂⁻; FPF₅⁻; FAsF₅⁻; FReF₅⁻; OTeF₅⁻; R₁R₂C(SO₂CF₃)₂; R₁N(SO₂CF₃)₂; R₁R₂P—CH₂—CH₂—PR₃R₄; theroyltrifluoroacetones; (C₆H₁₁)₂P(CH₂)₃P(C₆H₁₁)₂; ^{t}Bu₂P(CH₂)₂P ^{t}Bu₂; (C₆H₁₁)₂P(CH₂)₃P(C₆H₂)₂; ^{t}Bu₂P(CH₂)₃P ^{t}Bu₂; o-^{t}Bu₂PCH₂C₆H₄CH₂P ^{t}Bu₂; OPR₄₀R₄₁O; 1,3-diketones; benzoylbenzoate; trifluoro-2-furylacetylacetone; phthalates; naphthalates; dinaphthoylmethide; dipyridines; terpyridines; 2,2′-bypyridine-1,1′-dioxide, 2,2′,6′,2″-terpyridine; 4,4′-dimethyl-2,2′-dipyridine; phenanthrolines; o-phenanthroline isothiocyanate; trioctylphosphine oxide; perfluorinated sulfonate polymers; phenantroline; thenoyltrifluoroacetylacetonate; R₄₂C(OH)CHCOR₄₃; anions of aromatic carbonic acids; benzoic acid; picolinic acid; dipicolinic acid; trialkyl-, alkylphenyl-, and triphenyl-phosphinoxide; dialkyl-, alkylphenyl-, and diphenyl-sulfoxide; alkyl-, alkylphenyl-, and phenyl-amine; alkyl-, alkylphenyl-, and phenylphosphate; 2,2′,6,2″terpyridine; 1,10-phenantroline; N,N,N′,N′-tetramethylethylene diamine; [C₆H₅C(O)CH₂]P(O)(OH)₂; [C₆H₅C(O)CH₂]₂P(O)OH); [C₆H₅C(O)CH₂]₂P(O)OCH₃; [C₆H₅C(O)CH₂]₂P(O)OC₂H₅; [C₆H₅C(O)CH₂]₂P(O)OC₆H₄Cl; (C₆H₅)₂P(O)OH; (C₆H₅—CH═CH)₂P(O)OH; (C₆H₅—C≡C)₂P(O)OH; (C₆H₅)₂P(O)OH; (C₆H₅)(CH₃)P(O)OH; (CH₃)₂P(O)OH; (C₆H₅)₂As(O)OH; (CH₃)₂As(O)OH; C₆H₅C(O)OH; NH₃CH₂P(C₆H₅)O₂; lipids; polymers; polyamines; schiff bases; β-diketones; benzoyltrifluoroacetone; dibenzoylmethane; ditheonylmethane; furoylacetone; 2-furoylbenzoylmethane; 2-furoyltrifluoroacetone; hexafluoroacetylacetone; 1-acetyl-1-methyl acetone; β-naphthoyltrifluoroacetone; 2-theonylacetone; 2-theonyltrifluoroacetone (4,4,4-trifluoro-1,2-thienyl-1,3-butanedione); 1,1,1-trifluoroacetylacetone; 1,3-diphenyl-1,3-propanedione; 1-phenyl-1,3-butanedione; hydroxyaldehydes; 3-chlorosalicylaldehyde; 5-chlorosalicylaldehyde; 4,6-dimethylsalicylaldehyde; 2-hydroxy-1-naphthaldehyde; and 2-hydroxy-3-naphthaldehyde; hydroxy acids; salicylic acid; anthraquinone carboxylic acid; naphthoic acids; 8-hydroxyquinoline and its alkyl, aryl, and halo-substituted derivatives; —NCS; OPPh₃; NO₃; ethyne; R₁—CFCO₂⁻; S₂CNR₁R₂; S₂P(C₆HᵢFⱼ), where i+j=5; —N(Si(R₁)₃)(Si(R₂)₃); R₁R₂P═N—R₃; (n-C₈H₁₇)₃P═O; partial esters of mono-orthosilicic acid, diorthosilicic acid, triorthosilicic acid, tetraorthosilicic acid, pentaorthosilicic acid, monometasilicic acid, dimetasilicic acid, trimetasilicic acid, tetrametasilicic acid, pentametasilicic acid, dimesosilicic acid, trimesosilicic acid, tetramesosilicic acid, pentamesosilicic acid, triparasilicic acid, tetraparasilicic acid, pentaparasilicic acid, tetratetrerosilicic acid, pentatetrerosilicic acid, and penterosilicic acid; (n-C₈F₁₇)₂POOH; (n-C₆F₁₃)₂POOH; (i-C₃F₇OC₂F₄)₂POOH; (n-C₄F₉)₂POOH; [(CF₃)₂CF(CF₂)₆]POOH; [(CF₃)₂CF(CF₂)₆]PSOH; (n-C₁₀F₂₁)₂POOH; (CH₃)₃C—(CO)—CH₂—(CO)—CF₂CF₂CF₃; [NR₃A₈A₁₀R₁R₂]; [N(R₁)R₇₀(NR₂)]; [(NR₁R₂)(NR₃R₄)]; [R₇₅R₇₆A₂₅(A₂₆A₂₇)]; [R₅₀A₂₅(A₂₆A₂₇)]; 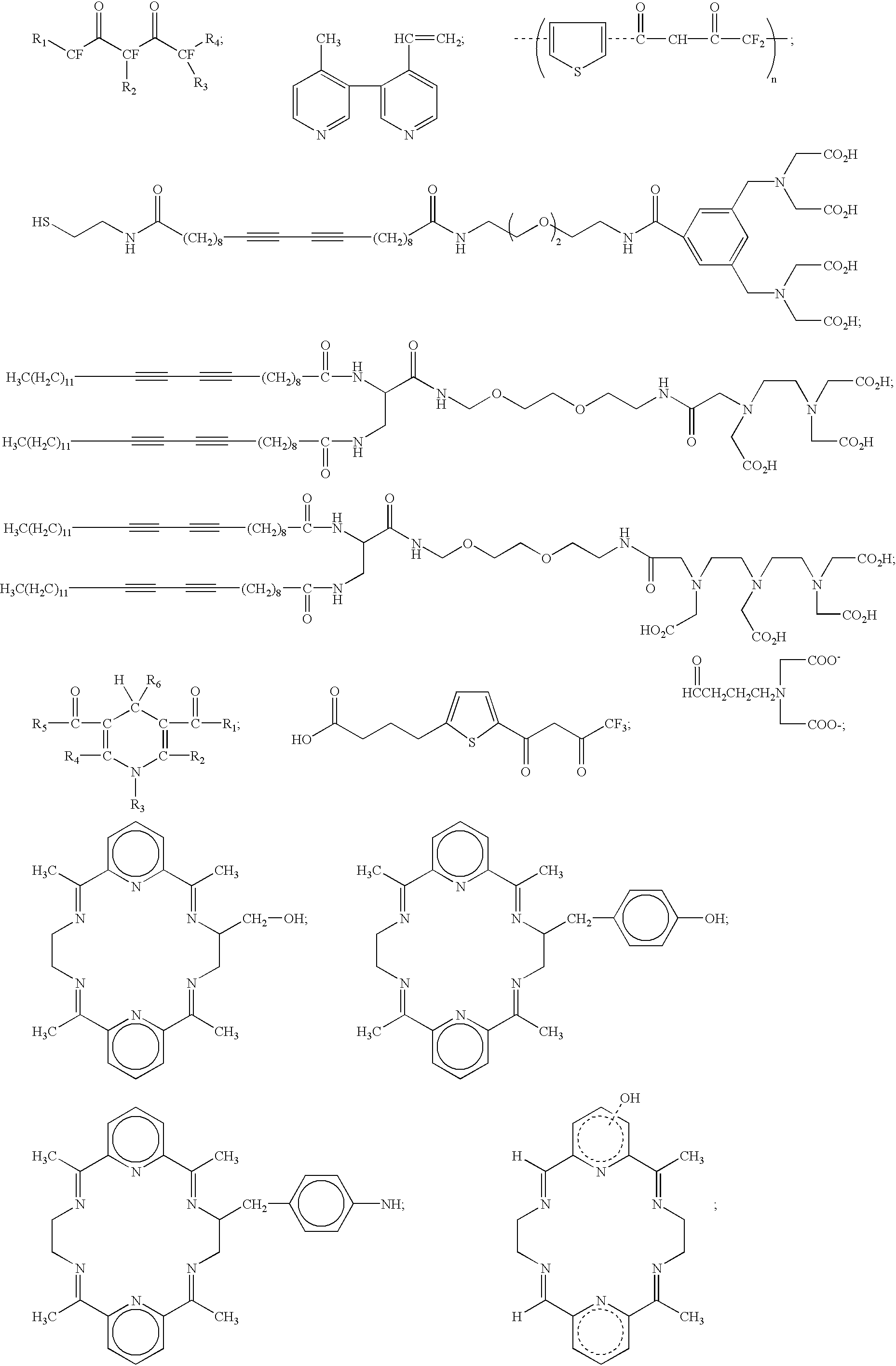
wherein
A₁ and A₂ can be the same or different and are selected from N, S and O;
A₃, A₄, A₅ and A₆ can be the same or different and are selected from P and N;
A₇ is selected from S and O;
A₈ and A₉ can be the same or different and are selected from O, S, Se, Te, Po and N;
A₁₀ is selected from B, Ge, Ga, N, P, As, Sb, Bi, S, C and Si, wherein if A₁₀ is C or Si then A₁₁R₁=nothing;
A₁₁ and A₁₂ can be the same or different and are selected from O, S, N, and nothing;
A₂₀, A₂₁, and A₂₂ can be the same or different and are selected from O, S, Se, Te and Po;
A₂₃ is selected from S, Se, Te and Po;
G is selected from nothing, p-C₆(X)₄, and p-C₆(X)₄—C₆(X₁)₄;
G₁₀, G₁₁, G₁₂, and G₁₃ can be the same or different and are 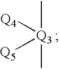
Q₁ and Q₂ can be the same or different and are selected from P, As and Sb;
Q₃ is selected from N, P, As and Sb;
Q₄ and Q₅ can be the same or different and are selected from O, S, Se and Te;
Q₆ is selected from B, As, and P;
Q₇ is selected from As and P;
Q₈ is selected from C and Si;
X, X₁, X₂, X₃, X₄, X₅, X₆, X₇ and X₈ can be the same or different and are selected from H, F, Cl, Br and I;
X₉ is selected from F, Cl, Br and I;
Z is Q₂(R₃)₃ or an oligophosphoranyl group;
n, m and p can be the same or different and are selected from any integer in the range of 1 to 100;
R_{f} is selected from perflourinated alkyl, perflourinated aryl, perflourinated cyclic alkyl, perflourinated arylalkyl, and perflourinated alkylaryl;
R₁, R₂, R₃, R₄, R₅, R₆, R₇ and R₈ can be the same or different, can be linked to form cyclic or extended structures, and are selected from halide, halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes and halogenated silazanes;
R₉ is selected from HO— and HS—;
R₁₀, R₁₁ and R₁₂ can be the same or different and are selected from R₅₀, R₅₁, R₅₂, R₅₃, R₆₀, R₆₀O—, R₆₀S—, R₆₁, R₆₁O—, R₆₁S—, HO— and HS—;
R₂₁, R₂₂ and R₂₃ can be the same or different and are selected from H, a branched or linear alkyl group having 1-50 carbon atoms, a branched or linear alkenyl group having 1-50 carbon atoms, a branched or linear halogenated alkyl group having 1-50 carbon atoms, —C(O)H, —COOH, —O—R₃₀, —O—R₃₀—OH, —R₃₀—OH, —COOR₃₀, COOR₃₀—C(O)H, —COOR₃₀—COOH, O—R₃₀—NH₂, —NO₂, and an amine group;
R₂₄, R₂₅ and R₂₆ can be the same or different and are selected from —(CH₂)₀-3COOH, —(CH₂)₀₋₃COOR₂₉, —(CH₂)₀₋₃SO₃H, —(CH₂)₀₋₃SO₃R₂₉, (CH₂)₀₋₃—O—P(O)(OR₂₉)₂, (CH₂)₀₋₃—O—P(O)OH(OR₂₉), —(CH₂)—O—P(OR₂₉)₃, —(CH₂)₀₋₃—O—POH(OR₂₉)₂, and —(CH₂)₀₋₃—O—P(O)H(OR₂₉);
R₂₇ and R₂₈ can be the same or different and are selected from —C(O)—O—R₃₀, —C(O)—COOH, —CH(O)—COOR₃₀, and —C(O)—NR₃₀R₃₀, and further may joined to form a cyclical compound selected from —CH₂—O—(CH₂—CH₂—O—)₀₋₃—CH₂—, —(CH₂—N(R₃₀)—CH₂)₁₋₄—, —C(O)—NR₃₀—R₃₁—NR₃₀—C(O)—, and —C(O)—O—R₃₁—O—C(O);
R₂₉ is a branched or linear alkyl group having 1 to 3 carbon atoms or a phenyl group;
R₃₀ is a branched or linear alkyl group or branched or linear alkenyl group having 1 to 50 carbon atoms;
R₃₁ is a branched or linear alkyl group having 2 to 8 carbon atoms;
R₄₀ and R₄₁ can be the same or different and are selected from H, F, CH₃, C₄H₉, C₅H₁₁, C₆H₅, C₆F₅, C₆H₁₃, C₇H₁₅, C₇H₇, C₈H₁₇, C₁₄H₁₂O, and CB₁₀H₁₀CCH₃;
R₄₂ and R₄₃ can be the same or different and are selected from F₃C—, thenoyl C₄H₃S—, furanoyl C₄H₃O—, t-butyl and perfluoro-n-propyl;
R₅₀, R₅₁, R₅₂, and R₅₃ can be the same or different and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, halogenated silazanes, 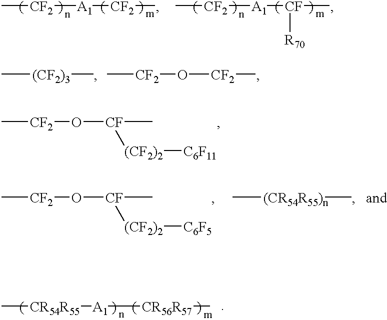
R₅₄, R₅₅, R₅₆, and R₅₇ can be the same or different and selected from F, Cl, Br, I, halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes and halogenated silazanes, halogenated polyamide, halogenated polyether, halogenated polyimide, halogenated polythioethers, —(CF₂)ₚ—CF₃, —(CF₂)ₚ—C₆F₅, and —(CF₂)ₚ—C₆F₁₁; and
R₆₀, R₆₁ and R₆₂ can be the same or different and are selected from alkyl, amyl, isoamyl, hexyl, heptyl, octyl, isomeric octyls, octadecyl, lauryl, normal or branched dodecyl, normal or branched tetradecyl, normal or branched cetyl, aryl, phenyl, diphenyl, naphthyl, aralkyl, phenyloctadecyl, alkaryl, octadecylphenyl, tetradecylphenyl, decylphenyl, hexylphenyl, methylphenyl, cetylphenyl, radicals containing ether, sulfide or ester groups, cyclic nonbenzenoid radicals, cyclohexyl, alicyclic radicals, oxy radicals, radicals containing thio, amino, or halogen, (where any of the R₆₀, R₆₁ and R₆₂ radicals can substituted or unsubstituted);
R₇₅ and R₇₆ can be the same or different and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes and halogenated silazanes;
wherein,
when two or more ligands are chosen and one or more variables from each ligand has the same designation, these variables can be the same or different for each ligand.

4. The composition of claim 3 wherein said at least one second ligand can be further halogenated, further fluorinated, perhalogenated or perfluorinated.

5. The composition of claim 3 wherein said at least one second ligand is selected from [C₆H₅C(O)CH₂]P(O)(OH)₂; [C₆H₅C(O)CH₂]₂P(O)OH); [C₆H₅C(O)CH₂]₂P(O)OCH₃; [C₆H₅C(O)CH₂]₂P(O)OC₂H₅; [C₆H₅C(O)CH₂]₂P(O)OC₆H₄Cl; (C₆H₅)₂P(O)OH; (C₆H₅—CH═CH)₂P(O)OH; (C₆H₅—C≡C)₂P(O)OH; (C₆H₅)₂P(O)OH; (C₆H₅)(CH₃)P(O)OH; (CH₃)₂P(O)OH; (C₆H₅)₂As(O)OH; (CH₃)₂As(O)OH; C₆H₅C(O)OH; NH₃CH₂P(C₆H₅)O₂; (n-C₈F₁₇)₂POOH; (n-C₆F₁₃)₂POOH; (i-C₃F₇OC₂F₄)₂POOH; (n-C₄F₉)₂POOH; [(CF₃)₂CF(CF₂)₆]POOH; [(CF₃)₂CF(CF₂)₆]PSOH; (n-C₁₀F₂₃)₂POOH; (CH₃)₃C—(CO)—CH₂—(CO)—CF₂CF₂CF₃; [NR₃A₈A₁₀R₁R₂]; [N(R₁)R₇₀(NR₂)]; [(NR₁R₂)(NR₃R₄)]; [R₇₅R₇₆A₂₅(A₂₆A₂₇)]; [R₅₀A₂₅(A₂₆A₂₇)];

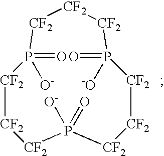

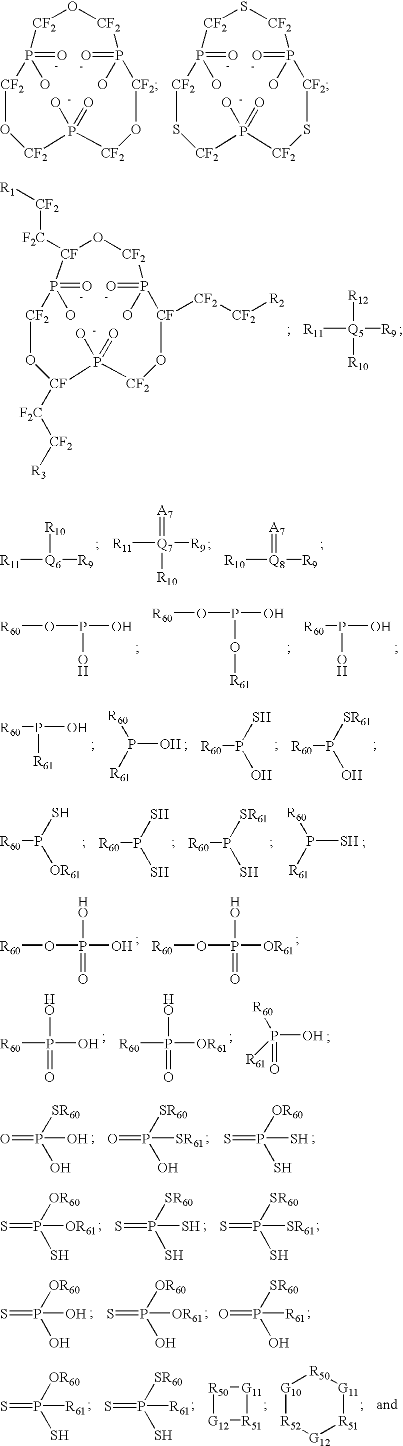

6. The composition of claim 1 wherein said composition comprises at least one complex selected from Er[(n-C₈F₁₇)₂POO]₃; ErYb[(n-C₈F₁₇)₂POO]₆; ErYb₄[(n-C₈F₁₇)₂POO]₁₅; ErYb[(n-C₆F₁₃)₂POO]₆; ErYb₄[(i-C₃F₇OC₂F₄)₂POO]₁₅; ErYb[(n-C₄F₉)₂POO]₆; ErYb₃[((CF₃)₂CF(CF₂)₆)₂POO]₁₂; ErYb₃[((CF₃)₂CF(CF₂)₆)₂PSO]₁₂; ErYb₃[(n-C₁₀F₂₃)₂POO]₁₂; ErYb₃[(n-C₈F₁₇)(n-C₁₀F₂₃)POO]₁₂; Er[(CH₃)₃C—(CO)—CH₂—(CO)—CF₂CF₂CF₃]₃; ErYb[(n-C₈F₁₇)₂POO]₆; ErYb₁₀[(n-C₈F₁₇)₂POO]₃₃; 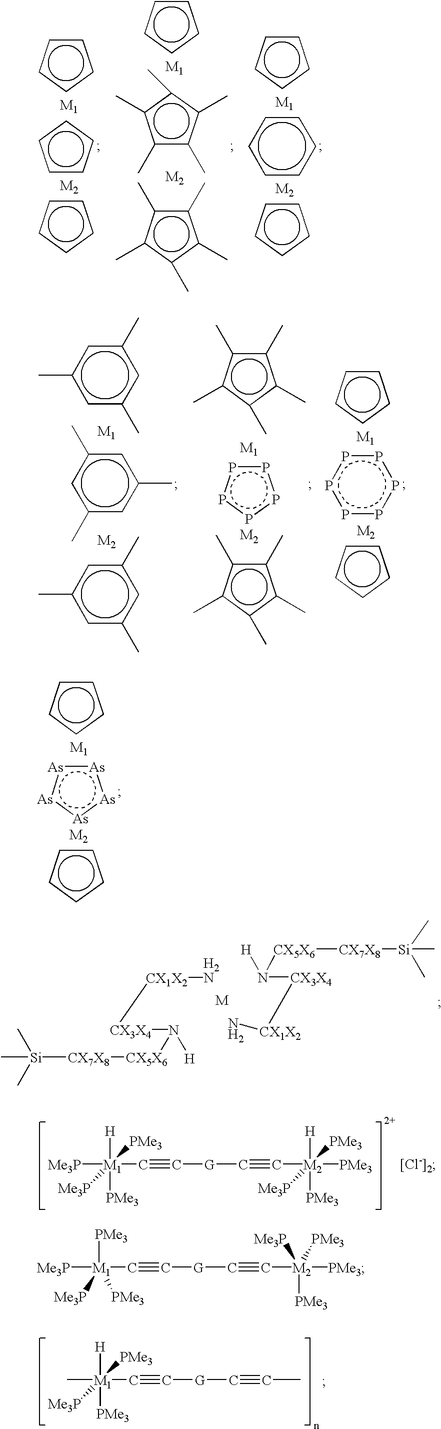
[M(PMe₃)₄]Cl;
M[N(Si(CH₃)₃)₂]₃;
M[N(Si(CH₃)₃)₂]₃OPPh₃;
[M(CH₂Si(CH₃)₃)₄]⁻;
[M(NCS)₆]³⁻;
Na[M(S₂CN(C₂H₅)₂)₄];
[M(mesityl)₄]⁻;
M(CF₃CO₂)₃(C₄H₈SO)₂;
Cs[M(CF₃COCFCOCF₃)₄];
M(PF-acac)₃;
M(HMPA)₃(X₉)₃;
M(OPPh₃)₃;
(DMSO)ₙM(NO₃)₃;
M[N(Si(CH₃)₃)₂]₂(Al(CH₃)₃)₂;
(M)₃en₃(X₉)₃;
[Men₄CF₃SO₃]²⁺;
[M[NCS)₆]³⁻;
[M(S₂CNR₂)₄]⁻;
[M(S₂P(CH₃)₂)₄]⁻;
M[S₂P(C₆H₁₁)₂]₃;
Cp₂MC₆F₅;
M(C₈H₈);
[M(C₈H₈)₂)²⁻;
M₁M₂M₃[(A₈A₉)A₁₀(A₁₁R₁)(A₁₂R₂)]₃;
M₁M₂M₃[NR₃A₈A₁₀R₁R₂]₃;
M₁M₂M₃[N(R₁)R₇₀(NR₂)]X₉;
(M₁)ᵢ(M₂)ⱼ(M₃)ₖ(M₄)ₗ[R₇₅R₇₆A₂₅(A₂₆A₂₇)]₃₍ᵢ₊ⱼ₊ₖ₊ₗ₎;
(M₁)ᵢ(M₂)ⱼ(M₃)ₖ(M₄)ₗ[R₅₀A₂₅(A₂₆A₂₇)]₃₍ᵢ₊ⱼ₊ₖ₊ₗ₎;
(M₁)ᵢ(M₂)ⱼ(M₃)ₖ(M₄)ₗ[R₅₀A₂₅(A₂₆A₂₇)R₅₁A₂₈(A₂₉A₃₀)]_{1.5(i+j+k+l)};
M₁M₂M₃](NR₁R₂)(NR₃R₄)]X₉; and
M₁M₂M₃[A₂₀A₂₁A₂₂A₂₃R₁]₃;
wherein,
A₈ and A₉ can be the same or different and are selected from O, S, Se, Te, Po and N;
A₁₀ is selected from B, Ge, Ga, N, P, As, Sb, Bi, S, C and Si (wherein if A₁₀ is C or Si then A₁₁R₁=nothing);
A₁₁ and A₁₂ can be the same or different and are selected from O, S, N, and nothing;
A₂₀, A₂₁, and A₂₂ can be the same or different and are selected from O, S, Se, Te and Po;
A₂₃ is selected from S, Se, Te and Po;
M, M₁, M₂, M₃ and M₄ can be the same or different and are selected from aluminum (Al), chromium (Cr), scandium (Sc), yttrium (Y), lutetium (Lu), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm) and ytterbium (Yb);
G is selected from nothing, p-C₆(X)₄, and p-C₆(X)₄—C₆(X₁)₄;
G₁₀, G₁₁, G₁₂, and G₁₃ can be the same or different and are 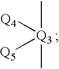
Q₃ is selected from N, P, As and Sb;
Q₄ and Q₅ can be the same or different and are selected from O, S, Se and Te;
X, X₁, X₂, X₃, X₄, X₅, X₆, X₇ and X₈ can be the same or different and are selected from H, F, Cl, Br and I;
X₉ is selected from F, Cl, Br and I;
n, m and p can be the same or different and are selected from any integer in the range of 1 to 100;
i, j, k and l can be the same or different and can be any positive, rational number from greater than zero to 1000;
R₁, R₂, R₃, R₄, R₅, R₆, R₇ and R₈ can be the same or different, can be linked to form cyclic or extended structures, and are selected from halide, halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes and halogenated silazanes;
R₅₀, R₅₁, R₅₂, and R₅₃ can be the same or different and are selected from halide, halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, halogenated silazanes, 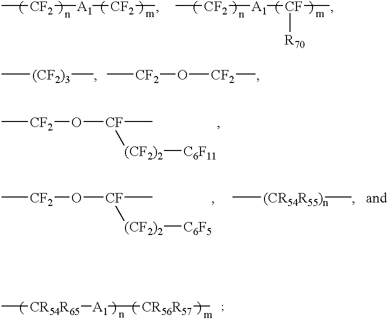
R₅₄, R₅₅, R₅₆, and R₅₇ can be the same or different and selected from F, Cl, Br, I, halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes and halogenated silazanes, halogenated polyamide, halogenated polyether, halogenated polyimide, halogenated polythioethers, —(CF₂)ₚ—CF₃, —(CF₂)ₚ—C₆F₅, and —(CF₂)ₚ—C₆F₁₁;
R₇₀ is halogenated alkylene or halogenated silylene; and
R₇₅ and R₇₆ can be the same or different and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes and halogenated silazanes;
wherein,
each of the [NR₃A₈A₁₀R₁R₂] can be the same or different; and
when two or more ligands are part of the same complex and one or more variables from each ligand has the same designation, these variables can be the same or different for each ligand.

7. The composition of claim 6 wherein the ligands in said at least one complex can be further halogenated, further fluorinated, perhalogenated or perfluorinated.

8. The composition of claim 6 wherein said composition comprises at least one of complex selected from Er[(n-C₈F₁₇)₂POO]₃; ErYb[)n-C8F17)₂POO]₆; ErYb₄[(n-C₈F₁₇)₂POO]₁₅; ErYb[(n-C₆F₁₃)2POO]₆; ErYb₄[(i-C₃F₇OC₂F₄)₂POO]₁₅; ErYb[(n-C₄F₉)₂POO]₆; ErYb₃[((CF₃)₂CF(CF₂)₆)₂POO]₁₂; ErYb₃[((CF₃)₂CF(CF₂)₆)₂PSO]₁₂; ErYb₃[(n-C₁₀F₂₃)₂POO]₁₂; ErYb₃[(n-C₈F₁₇)(n-C₁₀F₂₃)POO]₁₂; Er[(CH₃)₃C—(CO)—CH₂—(CO)—CF₂CF₂CF₃]₃; ErYb[n-C₈F₁₇)₂POO]₆; ErYb₁₀[(n-C₈F₁₇)₂POO]₃₃;

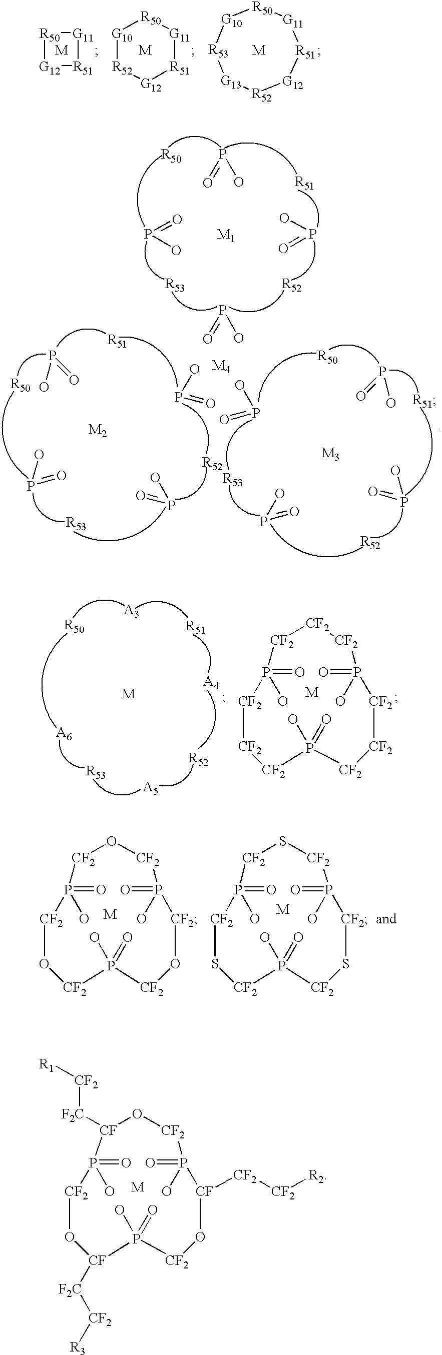

9. The composition of claim 1 wherein one of the suitable metals is Er or Yb.

10. The composition of claim 1 wherein two of the suitable metals are Er and Yb.

11. The composition of claim 1 wherein the total concentration of the at least one suitable metal is in the range of about 1×10⁻³ M to about 3.0 M.

12. The composition of claim 1 wherein the total concentration of the at least one suitable metal is in the range of about 1×10⁻² M to about 2.0 M.

13. The composition of claim 1 wherein the total concentration of the at least one suitable metal is in the range of about 0.01% (wt/wt) to about 20% (wt/wt).

14. The composition of claim 1 wherein the total concentration of the at least one suitable metal is in the range of about 0.1% (wt/wt) to 10% (wt/wt).

15. The composition of claim 1 wherein said composition has an absorbance per centimeter of less than about 5×10⁻⁵ in a wavelength range of about 1200 to about 2000 nm.

16. The composition of claim 15 wherein said wavelength range is about 1200 nm to about 1700 nm.

17. The composition of claim 15 wherein said wavelength range is about 1500 nm to about 1600 nm.

18. The composition of claim 15 wherein said wavelength range is about 1250 nm to about 1350 nm.

19. The composition of claim 15 wherein said absorbance per centimeter is less than about 2.5×10⁻⁵.

20. The composition of claim 15 wherein said absorbance per centimeter is less than about 1×10⁻⁵.

21. The composition of claim 1 wherein the total concentration of the at least one suitable metal is greater than about 0.1% and the lifetime of the composition is greater than about 1.5 ms.

22. The composition of claim 1 wherein the total concentration of the at least one suitable metal is greater than about 5.9% and the lifetime of the composition is greater than about 5.0 ms.

23. The composition of claim 1 wherein the total concentration of the at least one suitable metal is greater than about 1.0% and the lifetime of the composition is greater than about 3.8 ms.

24. A method of making a complex comprising at least one suitable metal and at least one acid, wherein said method comprises
(a) admixing at least one acid in at least one hydroxide salt in an inert solvent to produce at least one first salt;
(b) optionally, recovering said at least one first salt;
(c) admixing said at least one first salt with at least one second salt, wherein the at least one second salt comprises at least one suitable metal;
(d) optionally, stirring for up to about 72 hours; and
(e) recovering said complex.

25. The method of claim 24 wherein the cations of said at least one hydroxide salt are selected from Na, K, NH₄, Rb, Cs, Be, Mg, Ca, Sr, and Ba.

26. The method of claim 25 wherein said cations are selected from Na, K and NH₄.

27. The method of claim 24 wherein said inert solvent is selected from a polar solvent, acetone, methanol, propanol, acetonitrile and water.

28. The method of claim 24 wherein in step (b) the at least one first salt is recovered.

29. The method of claim 24 wherein in step (c) the at least one first salt is admixed with at least two second salts, wherein each said second salt, optionally comprises a different suitable metal.

30. The method of claim 24 wherein there is stirring in step (d).

31. The method of claim 24 wherein said stirring is under N₂.

32. The method of claim 24 wherein said stirring occurs for up to about 48 hours.

33. The method of claim 24 wherein said stirring occurs for up to about 2 hours.

34. The method of claim 24 wherein the said stirring occurs for up to about 1 minute.

35. The method of claim 24 wherein between step (d) and (e), there is a washing step.

36. The method of claim 24 wherein said at least one acid is a phosphorus-containing acid.

37. The method of claim 24 wherein said at least one acid is selected from phosphonic acid, [C₆H₅C(O)CH₂]P(O)(OH)₂; [C₆H₅C(O)CH₂]₂P(O)OH); [C₆H₅C(O)CH₂]₂P(O)OCH₃; [C₆H₅C(O)CH₂]₂P(O)OC₂H₅; [C₆H₅C(O)CH₂]₂P(O)OC₆H₄Cl; (C₆H₅)₂P(O)OH; (C₆H₅—CH═CH)₂P(O)OH; (C₆H₅—C≡C)₂P(O)OH; (C₆H₅)₂P(O)OH; (C₆H₅)(CH₃)P(O)OH; (CH₃)₂P(O)OH; (C₆H₅)₂As(O)OH; (CH₃)₂As(O)OH; C₆H₅C(O)OH; NH₃CH₂P(C₆H₅)O₂; (n-C₈F₁₇)₂POOH; (n-C₆F₁₃)₂POOH; (i-C₃F₇OC₂F₄)₂POOH; (n-C₄F₉)₂POOH; [(CF₃)₂CF(CF₂)₆]POOH; [(CF₃)₂CF(CF₂)₆]PSOH and (n-C₁₀F₂₃)₂POOH.

38. The method of claim 24 wherein said at least one suitable metal is Eb, Yb, or Er and Yb.

39. The method of claim 24 wherein at least one of the anions of the said at least one second salt is selected from Cl, Br, nitrate and acetate.

40. A composition comprising at least one complex selected from
(M₁ )ᵢ(M₂)ⱼ(M₃)ₖ(M₄)ₗ[R₇₅R₇₆A₂₅(A₂₆A₂₇)]₃₍ᵢ₊ⱼ₊ₖ₊ₗ₎;
(M₁)ᵢ(M₂)ⱼ(M₃)ₖ(M₄)ₗ[R₅₀A₂₅(A₂₆A₂₇)]₃₍ᵢ₊ⱼ₊ₖ₊ₗ₎; and
(M₁)ᵢ(M₂)ⱼ(M₃)ₖ(M₄)ₗ[R₅₀A₂₅(A₂₆A₂₇)R₅₁A₂₈(A₂₉A₃₀)]_{1.5(i+j+k+l)}, where R₅₀ and R₅₁ are each linked to both A₂₅ and A₂₈;
where:
M₁, M₂, M₃, and M₄ can be the same or different and are selected from aluminum (Al), chromium (Cr), scandium (Sc), yttrium (Y), lutetium (Lu), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm) and ytterbium (Yb);
A₁ is N, S or O;
A₂₅, A₂₈ can be the same or different and are selected from P, As, Sb and Bi;
A₂₆ A₂₇, A₂₉ and A₃₀ can be the same or different and are selected from O, S, Se, Te and Po;
R₇₅ and R₇₆ can be the same or different and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes and halogenated silazanes;
R₅₀, and R₅₁ can be the same or different and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, halogenated silazanes, 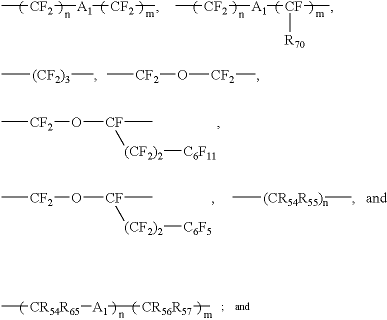
R₅₄, R₅₅, R₅₆, and R₅₇ can be the same or different and selected from F, Cl, Br, I, halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes and halogenated silazanes, halogenated polyamide, halogenated polyether, halogenated polyimide, halogenated polythioethers, —(CF₂)ₚ—CF₃, —(CF₂)ₚ—C₆F₅, and —(CF₂)ₚ—C₆F₁₁;
n, m and p can be the same or different and can be any integer from 1 to 20;
i, j, k and l can be the same or different and can be any positive, rational number from greater than zero to 1000.

41. The composition of claim 40 wherein the number of C-halide bonds are greater than the number of C—H bonds in R₅₀, R₅₁, R₇₅ and R₇₆.

42. The composition of claim 40 wherein the at least one complex has a halide-to-hydrogen weight percent equal to or greater than about 90%,

43. The composition of claim 40 wherein the number of C-halide bonds are greater than the number of C—H bonds in R₅₀, R₅₁, R₇₅, and R₇₆.

44. The composition of claim 40 wherein said at least one complex has a fluoride-to-hydrogen weight percent equal to or greater than about 90%,

45. The composition of claim 40 where i, j, k and l can be the same or different and can be any positive, rational number ranging from greater than 0 to 100.

46. The composition of 40 where i, j, k and l can be the same or different and can be any positive, rational number ranging from greater than zero to 25.

47. The composition of 40 where i, j, k and l can be the same or different and can be any positive, rational number ranging from greater than zero to 10.

48. The composition of claim 40 wherein one of M₁, M₂, M₃ or M₄ is Er or Yb.

49. The composition of claim 40 wherein two of M₁, M₂, M₃ or M₄ are Er and Yb.

50. The composition of claim 40 wherein the total concentration of the suitable metals is in the range of about 1×10⁻³ M to about 3.0 M.

51. The composition of claim 40 wherein the total concentration of the suitable metals is in the range of about 1×10⁻² M to about 2.0 M.

52. The composition of claim 40 wherein the total concentration of the suitable metals is in the range of about 0.01% (wt/wt) to about 20% (wt/wt).

53. The composition of claim 40 wherein the total concentration of the suitable metals is in the range of about 0.1% (wt/wt) to about 10% (wt/wt).

54. The composition of claim 40 wherein said composition has an absorbance per centimeter of less than about 5×10⁻⁵ in a wavelength range of about 1200 and about 2000 nm.

55. The composition of claim 54 wherein said wavelength range is about 1200 nm to about 1700 nm.

56. The composition of claim 54 wherein said wavelength range is about 1500 nm to about 1600 nm.

57. The composition of claim 54 wherein said wavelength range is about 1250 nm to about 1350 nm.

58. The composition of claim 54 wherein said absorbance per centimeter is less than about 2.5×10⁻⁵.

59. The composition of claim 54 wherein said absorbance per centimeter is less than about 1×10⁻⁵.

60. The composition of claim 40 wherein the total concentration of suitable metals is greater than about 0.1% and the lifetime of the composition is greater than about 1.5 ms.

61. The composition of claim 40 wherein the total concentration of suitable metals is greater than about 5.9% and the lifetime of the composition is greater than about 5.0 ms.

62. The composition of claim 40 wherein the total concentration of suitable metals is greater than about 1.0% and the lifetime of the composition is greater than about 3.8 ms.

63. The composition of claim 40 wherein said composition is an optical composition.

64. A method for preparing an optical gain medium comprising:
(a) admixing at least one complex with at least one suitable solvent to form a first mixture;
(b) heating the first mixture to between about 50° C. to about 150° C. for about 5 minutes to about 2 hours;
(c) cooling the first mixture to between about 20° C. to about 30° C.;
(d) admixing a perfluoropolymer with the first mixture to produce a second mixture;
(e) forming an optical gain medium from said second mixture;

65. The method of claim 64 wherein said at least one suitable solvent in step (a) is selected from DMAC, FC-75, CT Solv, CT Sol 100, CT Sol 130 and combinations thereof.

66. The method of claim 64 wherein said at least one suitable solvent in step (a) comprises DMAC, FC-75 and CT Solv 180.

67. The method of claim 64 wherein said heating in step (b) occurs in the range of about 60° C. to about 90° C.

68. The method of claim 64 wherein said heating in step (b) occurs at about 100° C.

69. The method of claim 64 wherein said heating in step (b) is for about 10 minutes to about 30 minutes.

70. The method of claim 64 wherein said cooling in step (c) is to about 25° C. or to about room temperature.

71. The method of claim 64 wherein said step (d) the perfluoropolymer is selected from cyclopolymerized perfluoro-vinyl ether; copolymers of 2,2-bistrifluoromethyl-4,5-difluoro-1,3 dioxole (PDD) with other suitable monomers; cyclic polyethers prepared from cyclopolymerization of fluorine-containing dienes; and polymer and copolymers of 2,2,4-trifluoro-5-trifluoromethoxy-1,3-dioxole with other suitable monomers.

72. The method of claim 64 wherein said step (d) the perfluoropolymer is a 16% (wt/wt) amorphous cyclopolymerized perfluoro-vinyl ether in a perfluoroether solvent.

73. The method of claim 64 wherein said forming in step (e) comprises filtering using about 0.45 microns or about 0.2 micron filters.

74. The method of claim 64 wherein said forming in step (e) comprises drying for about 1 to about 50 hours at a temperature of about 100° C. to about 150° C.

75. The method of claim 74 whereby the drying is for about 5 hours to about 10 hours.

76. The method of claim 74 wherein said temperature is about 130° C.

77. The method of claim 64 wherein said forming in step (e) comprises casting, film casting, spin casting, or film coating.

78. The method of claim 64 wherein said forming in step (e) comprises depositing said mixture on a substrate.

79. The method of claim 64 wherein said forming in step (e) comprises depositing said mixture on a silicon wafer.

80. An optical device comprising the composition of claim 1 or claim 40.

81. The optical device of claim 80 wherein said optical device is selected from optical fiber, waveguide, film, amplifier, laser, multiplexer, isolator, interleaver, demultiplexer, filter, highly-sensitive photodetector and switch.

82. An optical device comprising the gain medium prepared from the method of claim 64.

83. The optical device of claim 82 wherein said optical device is selected from optical fiber, waveguide, film, amplifier, laser, multiplexer, isolator, interleaver, demultiplexer, filter, photodetector and switch.

84. The composition of claim 1 wherein said at least one first ligand is selected from [C₆H₅C(O)CH₂]P(O)(OH)₂, [C₆H₅C(O)CH₂]₂P(O)OH), [C₆H₅C(O)CH₂]₂P(O)OCH₃, [C₆H₅C(O)CH₂]₂P(O)OC₂H₅, [C₆H₅C(O)CH₂]₂P(O)OC₆H₄Cl, (C₆H₅)₂P(O)OH, (C₆H₅—CH═CH)₂P(O)OH, (C₆H₅—C≡C)₂P(O)OH, (C₆H₅)₂P(O)OH, (C₆H₅)(CH₃)P(O)OH, (CH₃)₂P(O)OH, (C₆H₅)₂As(O)OH, (CH₃)₂As(O)OH, C₆H₅C(O)OH, NH₃CH₂P(C₆H₅)O₂, (n-C₈F₁₇)₂POOH; (n-C₆F₁₃)₂POOH, (i-C₃F₇OC₂F₄)₂POOH, (n-C₄F₉)₂POOH, [(CF₃)₂CF(CF₂)₆]POOH; [(CF₃)₂CF(CF₂)₆]PSOH, (n-C₁₀F₂₃)₂POOH, and (CH₃)₃C—(CO)—CH₂—(CO)—CF₂CF₂CF₃.

85. An amplifier comprising:
a first substantially planar reflector having a reflectivity that is about 100%;
a second substantially planar reflector having a reflectivity that is less than about 100%; and
a gain medium between said reflectors, said medium comprising:
at least one suitable metal selected from aluminum (Al), chromium (Cr), scandium (Sc), yttrium (Y), lutetium (Lu), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm) and ytterbium (Yb);
at least one first ligand; and
at least one second ligand,
wherein the at least one first ligand is selected from 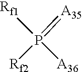
where
A₃₅ is selected from O and S;
A₃₆ is selected from —OH, —SH, and —OR₈₀;
R_{f1}, and R_{f2} can be the same or different, can be branched or unbranched, can be linked to form cyclic or extended structures, and are selected from halogenated alkyl, halogenated aryl, halogenated cyclic alkyl, halogenated arylalkyl, halogenated alkylaryl, halogenated ether, halogenated thioether, halogenated ether thioether, halogenated aklyl amino groups, halogenated alkylene, halogenated silylene, halogenated siloxanes, halogenated silazanes, halogenated olefins, fluorinated alkyl, fluorinated aryl, fluorinated cyclic alkyl, fluorinated arylalkyl, fluorinated alkylaryl, fluorinated ether, fluorinated thioether, fluorinated ether thioether, fluorinated aklyl amino groups, fluorinated alkylene, fluorinated silylene, fluorinated siloxanes, fluorinated silazanes, fluorinated olefins, branched perfluorinated C₁₋₂₀ alkyl, unbranched perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)2CFO(CF₂)₂; and
R₈₀ can be branched or unbranched and is selected from C₁₋₆ alkyl, C₁₋₁₅ alkyl, C₃₋₁₅ aryl, C₄₋₁₅ alkylaryl, and C₄₋15 arylalkyl.

86. An amplified splitter comprising:
an amplifier portion comprising:
at least one suitable metal is selected from aluminum (Al), chromium (Cr), scandium (Sc), yttrium (Y), lutetium (Lu), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm) and ytterbium (Yb);
at least one first ligand; and
at least one second ligand,
wherein the at least one first ligand is selected from 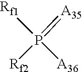
where
A₃₅ is selected from O and S;
A₃₆ is selected from —OH, —SH, and —OR₈₀;
R_{f1}, and R_{f2} can be the same or different, can be branched or unbranched, can be linked to form cyclic or extended structures, and are selected from halogenated alkyl, halogenated aryl, halogenated cyclic alkyl, halogenated arylalkyl, halogenated alkylaryl, halogenated ether, halogenated thioether, halogenated ether thioether, halogenated aklyl amino groups, halogenated alkylene, halogenated silylene, halogenated siloxanes, halogenated silazanes, halogenated olefins, fluorinated alkyl, fluorinated aryl, fluorinated cyclic alkyl, fluorinated arylalkyl, fluorinated alkylaryl, fluorinated ether, fluorinated thioether, fluorinated ether thioether, fluorinated aklyl amino groups, fluorinated alkylene, fluorinated silylene, fluorinated siloxanes, fluorinated silazanes, fluorinated olefins, branched perfluorinated C₁₋₂₀ alkyl, unbranched perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)2CFO(CF₂)₂; and
R₈₀ can be branched or unbranched and is selected from C₁₋₆ alkyl, C₁₋₁₅ alkyl, C₃₋₁₅ aryl, C₄₋₁₅ alkylaryl, and C₄₋15 arylalkyl; and an optical splitter portion optically coupled to said amplifier portion.

87. An optical chip comprising:
an optical amplifier comprising:
at least one suitable metal is selected from aluminum (Al), chromium (Cr), scandium (Sc), yttrium (Y), lutetium (Lu), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm) and ytterbium (Yb);
at least one first ligand; and
at least one second ligand,
wherein the at least one first ligand is selected from 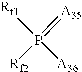
where
A₃₅ is selected from O and S;
A₃₆ is selected from —OH, —SH, and —OR₈₀;
R_{f1}, and R_{f2} can be the same or different, can be branched or unbranched, can be linked to form cyclic or extended structures, and are selected from halogenated alkyl, halogenated aryl, halogenated cyclic alkyl, halogenated arylalkyl, halogenated alkylaryl, halogenated ether, halogenated thioether, halogenated ether thioether, halogenated aklyl amino groups, halogenated alkylene, halogenated silylene, halogenated siloxanes, halogenated silazanes, halogenated olefins, fluorinated alkyl, fluorinated aryl, fluorinated cyclic alkyl, fluorinated arylalkyl, fluorinated alkylaryl, fluorinated ether, fluorinated thioether, fluorinated ether thioether, fluorinated aklyl amino groups, fluorinated alkylene, fluorinated silylene, fluorinated siloxanes, fluorinated silazanes, fluorinated olefins, branched perfluorinated C₁₋₂₀ alkyl, unbranched perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)2CFO(CF₂)₂; and
R₈₀ can be branched or unbranched and is selected from C₁₋₆ alkyl, C₁₋₁₅ alkyl, C₃₋₁₅ aryl, C₄₋₁₅ alkylaryl, and C₄₋15 arylalkyl; and
an integrated passive component selected from a group consisting of an arrayed waveguide grating, a splitter, a coupler, a static filter, a tunable filter.
